(19) United States
(12) Patent Application Publication
(10) Pub. No.: US 2016/0292386 A1
(43) Pub. Date: Oct. 6, 2016

(54) SYSTEMS AND ARCHITECTURE FOR ELECTRONIC INTERFACES AND COMPLEX DATA STRUCTURES FOR MEDICATION RECONCILIATION AND PATIENT REGIMEN ADHERENCE DETECTION

(71) Applicant: TruTag Technologies, Inc., Kapolei, CA (US)

(72) Inventors: Hod Finkelstein, El Cerrito, CA (US); Robert Kent Mansfield, Dallas, TX (US); Jeffrey N. Yu, Honolulu, HI (US)

(21) Appl. No.: 15/074,929

(22) Filed: Mar. 18, 2016

Related U.S. Application Data
(60) Provisional application No. 62/143,686, filed on Apr. 6, 2015.
(60) Provisional application No. 62/196,717, filed on Jul. 24, 2015.

(51) Int. Cl. G06F 19/00

(52) U.S. Cl. CPC G06F 19/3456; G06F 19/324; G06F 19/322

(57) ABSTRACT

Optical interference filters associated with specific, unique signatures are applied to medical consumables in order to label them. The interactions of those optical interface filters with electromagnetic waves can be observed in order to determine those unique signatures. These unique signatures can be used to look up entries in a database that contain information associated with the tagged medical consumable, allowing for the medical consumable to be easily identified and verified. Various systems and methods are provided herein that utilize these optical interference filters for performing medication reconciliation and tracking patient compliance to prescribed drug schedules, which can greatly reduce the errors and costs associated with medication reconciliation and monitoring patient compliance.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57.

This application claims benefit of U.S. Provisional Patent Application No. 62/196,717, filed Jul. 24, 2015, and titled “SYSTEMS, METHODS, AND DEVICES FOR DYNAMICALLY TRACKING PATIENT COMPLIANCE WITH MEDICAL CONSUMABLES.” This application also claims benefit of U.S. Provisional Patent Application No. 62/143,686, filed Apr. 6, 2015, and titled “MEDICATION COMPLIANCE AND RECONCILIATION PLATFORM.” The entire disclosure of each of the above items is hereby made part of this specification as if set forth fully herein and incorporated by reference for all purposes, for all that it contains.

### TECHNICAL FIELD

Embodiments of the present disclosure relate to systems and architecture for electronic interfaces and complex data structures for use in the related fields of medication reconciliation and monitoring patient compliance with medical consumables. More specifically, embodiments of the present disclosure relate to systems and architecture for electronic interfaces and complex data structures that can be used in dynamically identifying and verifying medical consumables, comparing medication to a patient's health records, and providing effective medication reconciliation and monitoring of patient compliance.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Medical consumables, such as pills, can be individually labeled with information about the medical consumable, such as the manufacturer, medication, dosage, form, and so forth. For example, pills are frequently stamped with numbers or letters which, when combined with the shape and color of the pill, can sometimes allow inferences to be made about the identity of the pill. Additionally, a container or package designed to hold medical consumables, such as a pill bottle, can be labeled with information about the medical consumable. However, labeling on a pill bottle may not be accurate and may not be enough in some circumstances, such as when the pills are separated from the pill bottle.

### SUMMARY

The systems, methods, and devices described herein each have several aspects, no single one of which is solely responsible for its desirable attributes. Without limiting the scope of this disclosure, several non-limiting features will now be discussed briefly.

The systems and methods of the present disclosure may be embodied in a computerized, electronic platform and are related to medication reconciliation and patient compliance. Such a system may comprise various hardware devices and/or software that are specifically designed to carry out portions of the medication reconciliation and patient compliance as contemplated.

Embodiments of the present disclosure relate to systems or methods to identify and verify medical consumables that have been incorporated with specially-configured optical interference filters. There may be a database that stores information about the medical consumables and any associated unique tag codes, which may be determined based on the characteristics of the optical interference filters incorporated into or onto the medical consumable. In some cases, the unique tag code may be just the unique signature associated with the optical interference filter that is determined from electromagnetic wave interactions. A user may be able to use a device, such as a scanner or reader, on a medical consumable in order to observe the characteristics of incorporated optical interference filters that are needed to look up the identity of the medical consumable in the database. In some embodiments, the device may be one or more devices, and may also comprise a custom software application that controls the device and enables the device to operate within the system.

Embodiments of the present disclosure also relate to systems or methods to carry out medication reconciliation and/or monitoring patient compliance. Since the system can identify and verify medical consumables, it can be used in either performing medication reconciliation or monitoring patient compliance depending on the user of the device.

In some embodiments, the user of the device may be seeking to verify the identity of the medical consumable in order to perform medication reconciliation. For example, the user may be a pharmacist looking to make sure that the correct drug has been prescribed to the patient, and that the correct drug is also being provided to the patient. The pharmacist would use the device on any medical consumables before they are distributed to a patient. In some of such embodiments, the device may be able to scan or enter shipment information and/or packaging barcodes, which may be stored in the database as well. The system may be able to compare the shipment information and/or packaging barcodes against the unique tag code of a medical consumable to determine that the correct drug is in the correctly-marked packaging, or to determine whether the drug has been recalled by the manufacturer. In some embodiments, the system may be able to obtain the medical records or prescriptions for the patient to whom the drug has been prescribed and compare that record against the unique tag code of the medical consumable in order to reduce prescription errors.

In some embodiments, the user of the device may be seeking to identify the identity of the medical consumable in order to report on patient compliance. For example, the user may be a patient that has been prescribed medication and has to provide evidence that they are complying with their prescribed drug schedule. The user would use the device on a medical consumable prior to, or along with, consumption of the medical consumable. In some of such embodiments, the system may be able to obtain a medical record or prescription for the patient to which the drug has been prescribed and compare that record against the medical consumable identified via the unique tag code in order to verify that the patient is taking the correct medication and in accordance to the prescribed schedule. In some of such embodiments, the system may be able to obtain an electronic medical record or electronic prescription for the patient. In some embodiments, information regarding the patient's continued compliance is collected. In some of such embodiments, that information is used for data mining or to generate a patient compliance report that may be distributed to various entities in the health care field. In other of such embodiments, that information is used to enter the patient into a lottery or provide the patient with prizes, in order to incentivize the patient to continue to comply with the prescribed drug schedule.

This disclosure contemplates various embodiments, some of which relate to a system for medication reconciliation and patient compliance that may comprise a prescribing doctor or nurse that issues a drug prescription to a patient; a dispensing pharmacy; the use of a drug cartridge, drug bag, or any other container that may be sealed or unsealed; the use of containers having built-in sensors for scanning and reading optical interference filters; a “medication assistant” instrument, reader, or scanning device that is capable of scanning and reading optical interference filters, and which have a feedback mechanism; a database containing the medical record for the patient; an optical interference filter manufacturing system, which may comprise a hardware and/or information system; a drug manufacturer's tagging system, a pharmacy tagging system, and/or a distributor tagging system, all of which may be comprised of hardware and/or an information system; an insurance company patient compliance information system and/or a hospital patient compliance information system; and a metadata consolidation and distribution system.

According to some embodiments, a non-transitory computer readable medium storing a program is disclosed. The program causing a computer to: receive patient-identifying information associated with a patient; receive a drug identification associated with a pharmaceutical dosage form associated with an optical interference filter, wherein the drug identification is obtained by: scanning the optical interference filter associated with the pharmaceutical dosage form via an emitter configured to emit an electromagnetic wave; receiving an energy spectrum associated with the optical interference filter via a receiver configured to receive the energy spectrum, wherein the energy spectrum is based on the electromagnetic wave interacting with the optical interference filter; determining one or more spectral energy features from the energy spectrum; determining a unique scanned tag code based on the characteristics of the one or more spectral energy features from the energy spectrum, wherein the unique scanned tag code is associated with the optical interference filter associated with the pharmaceutical dosage form; comparing the unique scanned tag code to a database containing the drug identification in order to determine a match; and upon determining the match, determining the drug identification associated with the unique scanned tag code and the optical interference filter. The program also causes the computer to: access a patient-record database containing an electronic prescription associated with the patient; determine the electronic prescription associated with the patient based on the received patient-identifying information associated with the patient; compare the received drug identification to the electronic prescription associated with the patient to determine patient compliance; and generate or update a patient compliance report based on the determined patient compliance.

In some embodiments, the pharmaceutical dosage form comprises a solid, semi-solid, or liquid dosage form. In some embodiments, the pharmaceutical dosage form is a solid or semi-solid oral dosage form that comprises pills, tablets, capsules, gel caps, caplets, powders, crystals, thin-films, or other orally-consumable forms of medication. In some embodiments, the pharmaceutical dosage form is a liquid dosage form that comprises creams, gels, liniments, balms, lotions, injectable solutions and mixtures, ointments, or other liquid forms of medication. In some embodiments, the pharmaceutical dosage form is coated with, or otherwise incorporated with, the optical interference filter associated with the pharmaceutical dosage form. In some embodiments, the optical interference filter associated with the pharmaceutical dosage form is added into an outer coating of the pharmaceutical dosage form, distributed on the outer layer of an uncoated pharmaceutical dosage form, and/or distributed throughout the pharmaceutical dosage form. In some embodiments, the optical interference filter associated with the pharmaceutical dosage form is incorporated within the pharmaceutical dosage form. In some embodiments, the electromagnetic wave may have a wavelength in the visible spectral range from 390 to 750 nm. In some embodiments, the energy spectrum may include, but is not limited to, the visible spectral range from 390 to 750 nm. In some embodiments, the optical interference filter comprises a layered Bragg-like filter. In some embodiments, the optical interference filter comprises a rugate filter. In some embodiments, the optical interference filter comprises a rugate microtag, wherein the rugate microtag is a rugate filter made of porous silicon, a rugate filter made of porous silica, or a rugate filter having varying proportions of both porous silicon and porous silica. In some embodiments, each spectral energy feature in the one or more spectral energy features is a rugate spectral peak in the received energy spectrum of the rugate microtag, wherein each rugate spectral peak is associated with a different sinusoidal component of an electrochemical etching waveform used to manufacture the rugate microtag. In some embodiments, the characteristics of the one or more spectral energy features used to determine the unique scanned tag code are associated with the different sinusoidal components of the electrochemical etching waveform. In some embodiments, the optical interference filter has a characterized shape, and wherein the unique scanned tag code is further determined based on the shape of the optical interference filter. In some embodiments, the optical interference filter comprises one or more rugate microtags, wherein the one or more rugate microtags are arranged in a pattern detectable using an imaging device, and wherein the unique scanned tag code is further determined based on the pattern of the one or more rugate microtags. In some embodiments, the pattern of the one or more rugate microtags comprises a geometric shape or a bar code. In some embodiments, the program stored on the non-transitory computer readable medium is further configured to cause a computer to alert a patient or a doctor based on the comparison of the received drug identification to the electronic prescription associated with the patient. In some embodiments, the received drug identification is associated with a drug taken by the patient, and alerting the patient or the doctor if the drug to be taken is: incorrect, out of date, out of compliance, and/or recalled. In some embodiments, the optical interference filter associated with the pharmaceutical dosage form is incorporated within, or on, a container holding the pharmaceutical dosage form. In some embodiments, the container holding the pharmaceutical dosage form comprises a blister pack.

According to some embodiments, a computer-based patient compliance system is disclosed. The system comprising: one or more computer readable storage devices configured to store a plurality of computer executable instructions; and one or more hardware computer processors in communication with the one or more computer readable storage devices and configured to execute the plurality of computer executable instructions in order to cause the computer system to: receive patient-identifying information associated with a patient; receive a drug identification associated with a pharmaceutical dosage form associated with a microtag, wherein the drug identification is obtained by: scanning the microtag associated with the pharmaceutical dosage form via an emitter configured to emit an electromagnetic wave, wherein the microtag has a varying porosity based on one or more etching currents used to manufacture the microtag, each etching current having variable parameters; receiving an energy spectrum associated with the microtag via a receiver configured to receive the energy spectrum, wherein the energy spectrum is based on the electromagnetic wave interacting with the varying porosity of the microtag; determining one or more spectral energy features from the energy spectrum, wherein each spectral energy feature has characteristics partly determined by the variable parameters of one of the etching currents used to manufacture the microtag; determining a unique scanned tag code based on the characteristics of the one or more spectral energy features from the energy spectrum, wherein the unique scanned tag code is associated with the microtag associated with the pharmaceutical dosage form; comparing the unique scanned tag code to a database containing the drug identification in order to determine a match; and upon determining the match, determining the drug identification associated with the unique scanned tag code and the microtag; access a patient-record database containing an electronic prescription associated with the patient; determine the electronic prescription associated with the patient based on the received patient-identifying information associated with the patient; compare the received drug identification to the electronic prescription associated with the patient to determine patient compliance; and generate or update a patient compliance report based on the determined patient compliance.

According to some embodiments, a computer-based patient compliance system is disclosed. The system comprising: one or more computer readable storage devices configured to store a plurality of computer executable instructions; and one or more hardware computer processors in communication with the one or more computer readable storage devices and configured to execute the plurality of computer executable instructions in order to cause the computer system to: receive patient-identifying information associated with a patient; receive, from a scanning device, one or more drug identifications, wherein each drug identification is obtained from a pharmaceutical dosage form that is associated with a microtag, and wherein each drug identification is obtained by: scanning the microtag associated with the pharmaceutical dosage form via an emitter configured to emit an electromagnetic wave, wherein the microtag has a varying porosity based on one or more etching currents used to manufacture the microtag, each etching current having variable parameters; receiving an energy spectrum associated with the microtag via a receiver configured to receive the energy spectrum, wherein the energy spectrum is based on the electromagnetic wave interacting with the varying porosity of the microtag; determining one or more spectral energy features from the energy spectrum, wherein each spectral energy feature has characteristics partly determined by the variable parameters of one of the etching currents used to manufacture the microtag; determining a unique scanned tag code based on the characteristics of the one or more spectral energy features from the energy spectrum, wherein the unique scanned tag code is associated with the microtag associated with the pharmaceutical dosage form; comparing the unique scanned tag code to a database containing drug information in order to determine a match; and upon determining the match, determining the drug identification associated with the unique scanned tag code and the microtag; access a patient-record database containing an electronic medical record associated with the patient; determine the electronic medical record associated with the patient based on the received patient-identifying information associated with the patient; determine, from the electronic medical record, a list of drugs prescribed to the patient; compare the two or more received drug identifications to the list of drugs prescribed to the patient; determine any adverse drug interactions between the drugs in the list of drugs prescribed to the patient and the two or more received drug identifications; and generate a drug interaction report identifying any determined adverse drug interactions between the drugs in the list of drugs prescribed to the patient and the two or more received drug identifications.

In some embodiments, the scanning device comprises: the emitter configured to emit the electromagnetic wave; the receiver configured to receive the energy spectrum based on the interaction of the electromagnetic wave and the microtag; a cartridge receiver, wherein the cartridge receiver is configured to receive a cartridge containing the one or more pharmaceutical dosage forms; a pharmaceutical dosage form selection mechanism, wherein the pharmaceutical dosage form selection mechanism is configured to select individual pharmaceutical dosage forms in the cartridge for drug identification; one or more computer readable storage devices configured to store a plurality of computer executable instructions; and one or more hardware computer processors in communication with the one or more computer readable storage devices and configured to execute the plurality of computer executable instructions in order to cause the scanning device to: determine that the cartridge receiver has received a cartridge containing the one or more pharmaceutical dosage forms; determine a total number of pharmaceutical dosage forms in the cartridge; emit, via the emitter, an electromagnetic wave at a single pharmaceutical dosage form in the cartridge; receive, via the receiver, the energy spectrum based on the interaction of the electromagnetic wave and the microtag associated with the single pharmaceutical dosage form; determine the one or more spectral energy features from the received energy spectrum; determine the unique scanned tag code based on the characteristics of the one or more spectral energy features; access the database containing the drug identification; compare the unique scanned tag code to the database containing the drug identification to determine a match; determine the drug identification associated with the unique scanned tag code and the microtag associated with the single pharmaceutical dosage form; operate the pharmaceutical dosage form selection mechanism to select a different pharmaceutical dosage form in the cartridge unless the drug identification for the total number of pharmaceutical dosage forms in the cartridge has been determined; and send one or more drug identifications corresponding to the total number of pharmaceutical dosage forms in the cartridge to the computer-based patient compliance system.

### BRIEF DESCRIPTION OF THE DRAWINGS

The following drawings and the associated descriptions are provided to illustrate embodiments of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1A is a system diagram that illustrates an environment in which one embodiment of the system for medication reconciliation and patient compliance may be implemented.

FIG. 1B is a system diagram that illustrates an environment in which one embodiment of the system for medication reconciliation and patient compliance may be implemented.

FIG. 2 is a process diagram that illustrates how medical consumables may be provided to a patient according to one embodiment of the system for medication reconciliation and patient compliance.

FIG. 3 is a block diagram that illustrates how medical consumables may be provided to a patient according to one embodiment of the system for medication reconciliation and patient compliance.

FIG. 4 is a block diagram that illustrates how medical consumables may be recalled according to one embodiment of the system for medication reconciliation and patient compliance.

FIG. 5 is a process diagram that illustrates how patient compliance with medical consumables can be tracked and monitored according to one embodiment of the system for medication reconciliation and patient compliance.

FIG. 6 is a block diagram that illustrates how medication reconciliation provides patients the correct medical consumable according to one embodiment of the system for medication reconciliation and patient compliance.

FIG. 7 is a block diagram that illustrates how a patient uses a device to monitor and report compliance according to one embodiment of the system for medication reconciliation and patient compliance.

FIG. 8 illustrates a block diagram that illustrates how patient compliance with medical consumables can be tracked according to one embodiment of the system for medication reconciliation and patient compliance.

FIG. 9 is a process diagram that illustrates how patient compliance with medical consumables can be tracked according to one embodiment of the system for medication reconciliation and patient compliance.

FIG. 10 is a process diagram that illustrates how patient compliance with medical consumables can be tracked according to one embodiment of the system for medication reconciliation and patient compliance.

FIG. 11 illustrates an example computer system in which one embodiment of the system for medication reconciliation and patient compliance may be implemented.

### DESCRIPTION OF THE EMBODIMENTS

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Introduction and General Overview

One way of labeling medical consumables and their containers is through the use of optical interference filters, which can be applied to, or incorporated within, the medical consumables and their containers. During the manufacturing process, these optical interference filters may be configured to interact with electromagnetic waves in a specific manner that allows a unique signature to be determined from the interaction. Thus, optical interference filters associated with a certain unique signature can be used as a “tag” that can be used to label the medical consumables that incorporate those optical interference filters.

The medical consumables can then be later identified or verified by determining the characteristics associated with the incorporated optical interference filters, such as for example, observing the interaction of those optical interference filters with electromagnetic waves to determine the unique signature associated with those optical interference filters.

The systems and methods described herein may be embodied in a computerized, electronic platform which can leverage these techniques of labeling, identifying, and verifying medical consumables using optical interference filters in order to perform medication reconciliation and monitor patient compliance of a medical consumable that has been prescribed to them by a doctor. This approach may be a significant improvement over having a third-party physically, and/or actively, perform medication reconciliation and monitor patient compliance, as that approach is constrained by the resources and availability of the third-party.

Medication reconciliation is the process of comparing a patient's medication orders to all of the medications that the patient has been taking. Patients are often confused by the medications they have and those that are newly prescribed. Patients may not be aware of when they should throw out old or expired medication. Patients may not necessarily have filled out the prescription for new medication. Patients may not be completely cognizant of existing medication that has been prescribed to them, so new medication may be duplicative, harmful, or unnecessary.

The medication reconciliation process is performed to avoid these medication errors, such as omissions, duplications, dosing errors, drug interactions, and so forth. Some estimates have determined that each year there are at least 1.5 million adverse drug events and $3.5 billion in associated financial burden as a result of medication errors, which could be prevented by improved medication reconciliation.

Currently, the reconciliation process is typically performed when the patient undergoes a transition in health care—such as changes in setting, service, practitioner, or level of care—which result in ordering new medications or rewriting existing orders. Pharmacists are usually the ones tasked with physically performing the reconciliation process, and it has supplanted the filling of prescriptions as the most valuable role for pharmacists. The fact that the current reconciliation process is generally performed in limited circumstances is likely a result of the requirement that a person physically perform the reconciliation.

Patient compliance is a separate concept that is closely related to the process of medication reconciliation. Whereas medication reconciliation is directed towards the question of whether a patient is taking the correct medication, patient compliance addresses the question of whether a patient is even taking the medication at all.

Patients sometimes do not finish their prescribed drug treatment regimen, and those patients are the ones that are likely to be readmitted to the hospital or require further treatment. For example, a patient may be prescribed antibiotics for a bacterial infection. The patient may stop taking the antibiotics once symptoms disappear, but before the infection is fully treated. This allows the infection to re-establish itself and could even result in the development of antibiotic-resistant bacteria.

Thus, ensuring that patients comply with their drug prescriptions is an important task. However, effective patient compliance is an ongoing challenge. Currently, ensuring patient compliance requires active monitoring or oversight. It can be done through third-party monitoring where someone checks to make sure the patient sticks to the treatment plan. It can also be done through self-monitoring where the patient provides updates of their compliance. However, the self-monitoring process can be problematic due to the risk that the patient is not completely truthful. Thus, third-party monitoring is presumably more effective. Unfortunately, active third-party monitoring cannot be employed in every instance because it requires a person carry out the monitoring and check in on the patient, and it would be cost-prohibitive to do that for every patient.

It stands to reason that the patient compliance and medication reconciliation processes are both constrained by a third-party having to actively, and physically, carry out the processes. Reducing the burden on third-parties in both processes would save money and time for both patients and third-parties. Improving accuracy and reliability of medication reconciliation would also reduce the amount of medication errors that go uncaught each year. Accordingly, there is a demand for accurate and reliable systems and methods, as disclosed herein, of performing medication reconciliation and tracking patient compliance with drug treatment plans that save money, time, and resources while reducing human error.

As previously mentioned, a key component to the systems and methods described herein is the use of optical interference filters (OIF), which can be applied to, or incorporated into, medical consumables and their containers. During the manufacturing process, these optical interference filters may be configured to interact with electromagnetic waves in a specific manner that allows a unique signature to be determined from the interaction. Thus, optical interference filters associated with a certain unique signature can be used as a “tag” that can be used to label the medical consumables that incorporate those optical interference filters. If the number of possible unique signatures is insufficient, then a unique tag code can be further defined and determined from the unique signature and any other identifiable characteristics of the optical interference filters (e.g., arrangement or shape), and used to increase the amount of possible unique identifiers.

Afterwards, the interaction of the optical interference filters with electromagnetic waves can be observed in order to determine the unique signature associated with those optical interference filters. The optical interference filter can be used with a device that can scan, read, or track the unique signature of the filter. In some cases, the device may use electromagnetic waves in the visible light spectrum, and the unique signature may be a unique optical signature. The unique signature can be used, optionally with any other identifiable characteristics of the optical interference filters, for determining a unique tag code that can serve as a digital fingerprint for any object that the optical interference filters are incorporated within. That digital fingerprint may be associated with the object within a database, which may contain further information about the object. In other words, the unique tag code or digital fingerprint may be a pointer that can be used to lookup information about the object containing the optical interference filters. Again, it is reiterated that in some embodiments, the unique tag code may be based solely off the unique signature, or the unique signature may be the unique tag code. Accordingly, optical interference filters provide a convenient way to label, identify, and verify objects.

By way of example, the optical interference filters can be micro-tags comprising one-time-programmable, edible, high-purity silica (silicon dioxide) or other similar materials, which can be used with pharmaceutical dosage forms when added to coatings, applied to the exterior of pharmaceuticals, or added to the ingredients of pharmaceuticals or other medical consumables. In other embodiments, the optical interference filters could be incorporated into an RFID, NFC, or electromagnetic tag. Examples and implementation methods of such tags are described in U.S. Pat. No. 6,294,999, titled “SYSTEMS AND METHODS FOR MONITORING PATIENT COMPLIANCE WITH MEDICATION REGIMENS”, and US Patent Pub. 20150310185, titled “IN-HOME IOT MEDICATION DEVICE”, both of which are incorporated by reference herein. However, the use of silica micro-tags may be advantageous in numerous aspects. In particular, the materials needed to make the micro-tags are abundant and silica is biologically inert, which lends well to being used with ingested medications.

As a general overview, the silica micro-tags can be encoded with unique signatures that can serve as a unique tag code or a component of the unique tag code, which are analogous to barcodes or digital fingerprints used to reference objects in a database. The unique signatures are associated with how each silica micro-tag is configured to interact with electromagnetic waves. After the silica micro-tags are applied to an object, they can then be scanned with an emitter of an electromagnetic wave or other source of electromagnetic waves. A receiver receives an energy spectrum, which is based on the interaction of the optical interference filter with the electromagnetic wave. In some instances, the emitter and receiver may be a single device collectively referred to as a “tag reader”.

The energy spectrum will have distinguishable spectral energy features. The characteristics of these one or more spectral energy features may be used to determine the unique signature associated with the silica micro-tag using various methods. Examples of the spectral energy features include spectral peak positions, spectral peak amplitudes, side lobes, and any other identifiable feature in the energy spectrum. Generally, these spectral energy features of the received energy spectrum will be related to various configurable inputs used in manufacturing the silica micro-tag. For example, the position and amplitude of a spectral peak may be associated with a sinusoidal component of an electrochemical etching waveform used to manufacture the micro-tag, and the parameters of that waveform may be modified. Thus, the manufacturing process can configure silica micro-tags to produce certain spectral energy features in the energy spectrum. The combination of those spectral energy features may be used to determine the unique signature associated with a silica micro-tag, which may then be used to determine a unique tag code associated with the object. This unique tag code may then be compared to reference tag codes stored in a database in order to identify or verify the object. In particular, the unique scanned tag code matches a reference tag code then the object exists in the database and information regarding the object can be looked up in the database.

This broad, but simplistic, overview of optical interference filters and silica micro-tags is provided out of convenience and overlooks many implementation details. For example, the optical interference filter may comprise a layered Bragg-like filter or a rugate filter. An optical interference filter may be a rugate filter made of porous silicon, porous silica, or varying proportions of both porous silicon and porous silica. More information on how silica micro-tags can be manufactured for use as a marker or identifier with an encoded unique signature, how an energy spectrum of the silica micro-tags can be analyzed to determine the unique signature with a micro-tag reader device, and additional silica micro-tag implementation details are provided in U.S. Pat. Nos. 8,596,546; 8,881,972; 9,033,213; 8,453,929; and U.S. Pat. No. 8,511,557, as well as U.S. application Ser. Nos. 13/158,254; 62/040,924; 62/076,893; 14/581,935; 14/576,054; and Ser. No. 14/723,014. The aforementioned references are incorporated by reference in their entirety.

As previously described, the systems and methods described herein can be embodied by a computerized, electronic platform. That system would leverage these techniques of labeling, identifying, and verifying medical consumables using optical interference filters in order to perform medication reconciliation and monitor patient compliance of a medical consumable that has been prescribed to them by a doctor. More specifically, the system may be able to access medical records or prescriptions associated with a patient, and then compare those records against any medical consumables identified via optical interference filters. In some embodiments, the system may access electronic medical records or electronic prescriptions. This information can be used to determine if there are any medication errors, such as any incompatible drugs the patient may already be taken, or if the patient is taking the correct medication that has been prescribed. The patient can also continually provide evidence of their compliance to the prescribed drug schedule by identifying the medical consumables via optical interference filters prior to consumption. This patient compliance data can be collected over time and used to generate a patient compliance report.

This approach may be a significant improvement over having a third-party physically, and/or actively, perform medication reconciliation and monitor patient compliance, as that approach is constrained by the resources and availability of the third-party. Furthermore, patients can be incentivized to comply with their prescribed drug schedules by entering them into a lottery, or providing them a prize, as a reward for continuing to provide evidence of their compliance through scanning their medical consumables using a micro-tag reader. What was previously a chore (taking medicine) is now a reward, which takes advantage of positive feedback loops that are better for building and reinforcing habits.

The terms optical interference filters (OIFs), filters, tags, and microtags may be used interchangeably and synonymously herein. As used herein, these terms are broad terms including their ordinary and customary meanings, and further include, but are not limited to any object that can interact with electromagnetic waves (any electromagnetic wave, and not only ones visible to the human eye) in a unique and repeatable manner, such that a unique signature or digital fingerprint can be determined based on the interaction.

The terms medical consumables, medications, and drugs may be used interchangeably and synonymously herein. As used herein, these terms are broad terms including their ordinary and customary meanings, and further include, but are not limited to pharmaceutical dosage forms in a solid, semi-solid, or liquid dosage form (e.g., pills, tablets, capsules, gel caps, caplets, powders, crystals, thin-films, or other orally-consumable forms of medication, creams, gels, liniments, balms, lotions, injectable solutions and mixtures, ointments, or other liquid forms of medication). These terms may also apply to non-pharmaceuticals or things that are not necessarily ingested, such as glucose monitoring strips, saline bags, and so forth.

### FIGURES

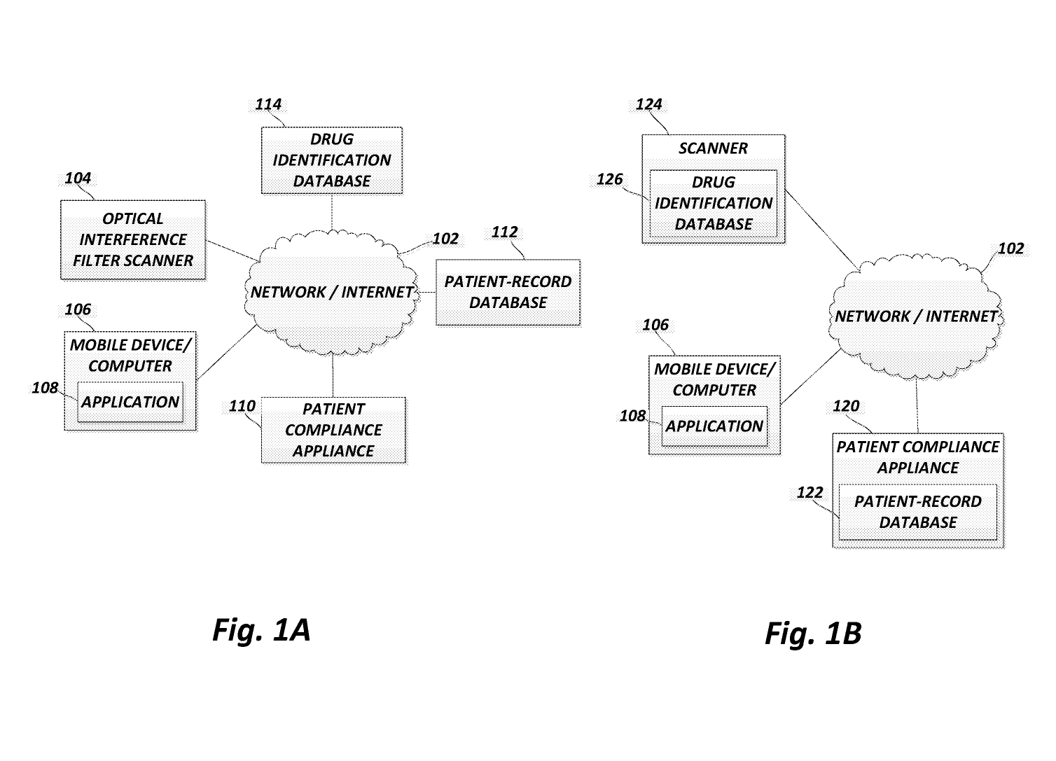

FIGS. 1A and 1B are system diagrams that illustrate example environments in which one embodiment of the system for medication reconciliation and patient compliance may be implemented.

With reference to FIG. 1A, the system comprises Network 102, Optical Interference Filter Scanner 104, Mobile Device 106 having Application 108, Patient Compliance Appliance 110, Patient-Record Database 112, and Drug Identification Database 114.

As shown in the figure, Network 102 is an abstraction and may actually comprise multiple different networks. Network 102 allows Optical Interference Filter Scanner 104, Mobile Device 106, Patient Compliance Appliance 110, Patient-Record Database 112, and Identification Database 114 to communicate with one another. In some embodiments, Network 102 is the Internet. Network 102 may consist of any communications network, such as a LAN, WAN, and so forth. Network 102 may also consist of any telecommunications network, such as the 3G network used by mobile devices. Thus, Patient Compliance Appliance 110, Patient-Record Database 112, and Identification Database 114 may be connected via the Internet, but may have to communicate with Interference Filter Scanner 104 and/or Mobile Device 106 via a telecommunications network.

Optical Interference Filter Scanner 104 is any device that allows the identification of medical consumables by scanning or reading optical interference filters incorporated with the medical consumable. In some embodiments, Optical Interference Filter Scanner 104 may scan or read optical interference filters incorporated with a medical consumable by emitting an electromagnetic wave and receiving an energy spectrum based on interactions between the optical interference filters and an electromagnetic wave. In some embodiments, Optical Interference Filter Scanner 104 comprises a “tag reader” which performs both the emitting and receiving functions. Examples of tag readers include scanning spectrometers or Fabry-Perot Interferometers (FPI).

In some embodiments, Optical Interference Filter Scanner 104 may be able to determine a unique signature from various spectral features in the energy spectrum. In some embodiments, Optical Interference Filter Scanner 104 may be able to determine a unique signature from various spectral features in the energy spectrum, whereas in other embodiments, the energy spectrum is sent to Patient Compliance Appliance 110 for the unique signature to be determined. In some embodiments, Optical Interference Filter Scanner 104 may be able to determine characteristics associated with optical interference filters, such as shape, size, and arrangement of the optical interference filters. For example, Optical Interference Filter Scanner 104 may have a camera and be capable of taking images of the optical interference filters that can be used to determine the characteristics of the filters. In some embodiments, Optical Interference Filter Scanner 104 may be used in combination with an embedded barcode scanner or with an image capture of a medical consumable or package in order to combine tag information from the medical consumable with the corresponding package barcode.

In some embodiments, the Optical Interference Filter Scanner 104 may be able to determine a unique scanned tag code based off of the unique signature of the filter, or a combination of the unique signature and other characteristics of the filters. Optical Interference Filter Scanner 104 may then be able to use the unique scanned tag code to query Drug Identification Database 108 for matching reference tag codes in order to identify the medical consumable containing the filter. However, in other embodiments, Optical Interference Filter Scanner 104 may be kept in the dark regarding how the unique scanned tag code is determined and only have an information-collecting role. For example, Optical Interference Filter Scanner 104 may only be able to collect the energy spectrum and an image of the filters, and that data is sent to Patient Compliance Appliance 110 which uses that data to determine the unique scanned tag code with which to query Drug Identification Database 108. By keeping the algorithm for generating the scanned tag code out of Optical Interference Filter Scanner 104 and the hands of users, the reverse-engineering and spoofing of scanned tag codes can be prevented.

In some embodiments, medical consumables, such as pills, are loaded into Optical Interference Filter Scanner 104 individually for scanning. In other embodiments, a custom input cartridge may be loaded into Scanner 104 with all the pills to be scanned. A signal is sent by Scanner 104 to the cartridge to release additional pills as the Scanner 104 is ready to start a new scan. A pill that has just been scanned may be sent to a collection cartridge, which may be the same cartridge as the input cartridge. In yet other embodiments, all pills may be placed on a carousel which rotates within Scanner 104 to scan one pill at a time. The Scanner 104 rotates the carousel to scan the next pill.

In some embodiments, Optical Interference Filter Scanner 104 may be a standalone device specifically designed for the systems and methods described herein, such that the device's primary function is to facilitate patient compliance and/or medication reconciliation. In some embodiments, the functions of receiving energy spectra and/or determining unique signatures or tag codes may be governed by software designed to run on the device. In some embodiments, the device may have hardware components or peripherals—such as a wave source—configured to emit electromagnetic waves. In some embodiments, the device may have hardware components or peripherals—such as a reader, scanner, or camera—configured to receive the energy spectrum or characteristics of the filters. The energy spectrum may be associated with any kind of electromagnetic wave(s), and as such, such hardware components or peripherals may be capable of receiving an energy spectrum and converting it into a readable signal. In some embodiments, the hardware components or peripherals may be integrated into the device itself, while in other embodiments, the hardware components or peripherals may be external to the device and configured to interface with the device.

In some configurations, Optical Interference Filter Scanner 104 may be configured to be paired with Mobile Device 106 and Application 108. For example, Optical Interference Filter Scanner 104 may have a design that makes it difficult to provide the user with necessary feedback or information. As a further example, Optical Interference Filter Scanner 104 may be a pillbox designed for use by a patient. Thus, Optical Interference Filter Scanner 104 may be configured to receive energy spectra and determine unique signatures associated with filters applied to medical consumables, while Mobile Device 106 and Application 108 are used to provide a user interface to the patient that can be used to conduct the compliance process and provide real-time feedback or important information, such as any discrepancies between the scanned medical consumable and information about that medication in Drug Identification Database 114. In other embodiments, Optical Interference Filter Scanner 104 may be configured to scan filters located on, or within, the container or packaging that a medical consumable may be in. For example, a medical consumable may come in a prescription vial or a packaged in a blister pack. Filters may be placed on, or within, the vial or the blister pack. Scanning those filters with Optical Interference Filter Scanner 104 may allow information regarding the contained medical consumable to be obtained.

However, it should be noted that Optical Interference Filter Scanner 104 need not be a standalone device. Alternatively, the functions of Optical Interference Filter Scanner 104 could be entirely swept into Mobile Device 106 running Application 108. Mobile Device 106 may be a commonplace electronic device, such as a mobile phone, smart phone, tablet, laptop, and so forth, which can be equipped or paired with the hardware components or peripherals needed to identify unique signatures (e.g., a camera, a RFID/Bluetooth reader, etc). Application 108 may be custom software designed to run on the device and leverage those hardware components or peripherals in order to receive energy spectrum or filter characteristics, determine unique signatures, communicate with Drug Identification Database 114 or Patient Compliance Appliance 110, and so forth. As a more specific example, Optical Interference Filter Scanner 104 could just be a patient's smart phone, such as an iPhone or Android phone, which can be paired with a sensor for receiving energy spectrum. The patient could download and run a custom software application that allows for the unique signature to be determined when the paired sensor receives the energy spectrum and the phone's camera could be used to identify characteristics of the filters on the medical consumable.

Optical Interference Filter Scanner 104 device may be capable of providing feedback or information to the user, such as through a speaker, flashing lights, display, or so forth. This device may also have some manner of receiving input from the user, such as buttons, a touch screen, a user interface, or so forth. However, these functions of providing feedback and receiving input could be performed through Application 108 of Mobile Device 106, which could be paired with the Scanner 104 or replace Scanner 104 entirely as previously mentioned.

Optical Interference Filter Scanner 104 may be usable by various kinds of users, such as a pharmacist or doctor performing the reconciliation process, a patient seeking to report out their compliance, a manufacturer or packager seeking to verify filters in medical consumables, and so forth. Thus, Optical Interference Filter Scanner 104 may be configured for various roles and/or user types, providing real-time feedback and information that is tailored to the role the device is being used for.

For example, in some embodiments, Optical Interference Filter Scanner 104 may be used by a patient during their day-to-day consumption of a medical consumable in order to report their compliance with a prescribed drug schedule. In some of such embodiments, Optical Interference Filter Scanner 104 may also be able to determine the available quantity of the medical consumable and/or the appropriate dose that the patient should take. In some embodiments, Optical Interference Filter Scanner 104 may be a device for a patient to use at home in order to monitor and/or track patient compliance and/or consumption of pharmaceuticals that have been tagged. In some embodiments, Optical Interference Filter Scanner 104 may comprise a pill box designed to analyze the medical consumables held within the device. In other embodiments, Optical Interference Filter Scanner 104 may be a toilet capable of analyzing optical interference filters that have gone through the patient to confirm patient compliance after consumption. In some embodiments, Optical Interference Filter Scanner 104 may be a handheld scanner.

Thus, a patient could record and report their compliance with their prescribed medication schedule using Optical Interference Filter Scanner 104 by scanning their medical consumable prior to consuming it. As an example, the patient could use Optical Interference Filter Scanner 104 having the previously-mentioned pill box design with their Mobile Device 106. The patient may insert a medical consumable into the pill box, which would identify the medication, dose, quantity, etc. of the medical consumable. The patient may then be directed to input information about the medication into a custom Application 108 running on their Mobile Device 106. After the unique scanned tag code associated with that medical consumable is determined, the system may then compare the scanned tag code against the reference tag codes contained in Drug Identification Database 114 to identify the medical consumable. The system may then compare the identified medical consumable to the information the patient provided about the medication to determine if there is a match. Any discrepancies can be reported back to the patient through Application 108.

Additionally, the system may also be able to take the role of medication reconciliation out of the hands of pharmacists at this point by reconciling the medication, dose, quantity, and any other pertinent information regarding the medical consumable, against the patient's medical records or prescriptions. The system may access Patient-Record Database 112 in order to determine the drugs that the patient has been prescribed and compare that to the identified medical consumable. If the patient is taking a medical consumable they have been prescribed, then the system would consider the patient to be in compliance with their prescribed schedule. Any discrepancies can be reported back to the patient through Optical Interference Filter Scanner 104 or Application 108. For example, the pill box may use sounds or visuals to communicate to the patient that the process was successful or unsuccessful, or the application on the patient's smart phone may provide that information to the patient. The system may also check for medication errors using the patient's records, to ensure that the patient is taking the correct medical consumable, that the medical consumable is not old or expired, and that the medication is not duplicative, harmful, or unnecessary given the patient's previous medical history or other medications the patient is currently taking. Thus, this medication reconciliation role can be performed by the system with high frequency, basically at any time the patient uses a medical consumable. This is a significant improvement over performing reconciliation only when the patient has obtained a new prescription and is visiting the pharmacist, since not all medical consumables require prescriptions. For example, an OTC medication may have adverse effects with another drug that the patient is currently taking. If the OTC medication was tagged appropriately, the system could inform the patient not to take the OTC medication and to contact the appropriate party to seek proper resolution of the issue.

In some embodiments, upon performing the medication reconciliation process for a patient, the system may send an updated list of medications that the patient is taking to update the patient's medical record held by various entities, such as health information exchanges, the primary care physician (PCP) or specialty doctors, medical labs, independent health facilities, pharmacies, academic medical centers, community hospitals, the government, insurance companies, and so forth. This may be easily performed if the updates are to an electronic medical record.

In some embodiments, the system may send notice to any relevant parties of any regimen changes for the patient. For example, the patient and their primary physician may be notified and updated with a regimen change. Additionally, a surgeon, a pharmacist, or any other health care professional may also be updated with notice of regimen changes. With all these parties kept up-to-date and informed of any regimen changes of the patient, the scenario in which the patient is administered drugs adverse to their existing drug regimen is reduced. In some of such embodiments, notices may be sent to the patient via the custom application on their smart phone. The notices may be saved or available for the patient to use as a reference, such as if the patient switches to a new doctor.

In some embodiments, Optical Interference Filter Scanner 104 may be used by a manufacturer or packager to verify that a valid and proper optical interference filter has been applied to a medical consumable, and to ensure proper tag application. For example, a drug manufacturer may regularly do quality control to make sure that a group of drugs being sold has been applied with the correct filters that correspond to that group of drugs in Drug Identification Database 114. Thus, Optical Interference Filter Scanner 104 may be used to identify medical consumables based on their tagged filters simply in order to verify that the tag is correct. An incorrect tag may be the result of the wrong tag being applied to the medical consumable, or it may reveal an error in Drug Identification Database 114.

In some embodiments, Optical Interference Filter Scanner 104 may be used by a distributor, such as a pharmacist, in order to verify a medical consumable's status and that it matches its packaging, that a medical consumable matches what was prescribed to a patient, and that the medication is appropriate for a patient given the patient's medical history.

To verify that a medical consumable matches its packaging, the distributor would use Optical Interference Filter Scanner 104 in a similar manner to that of a manufacturer. The distributor may scan a medical consumable to identify it and then compare it to labeling on its packaging. In scenarios where the packaging is transparent (i.e., a blister pack), the medical consumable can be identified without taking it out of its packaging. However, in some embodiments, the distributor may be able to use Optical Interference Filter Scanner 104 to scan or enter shipment information and/or packaging barcodes, which can also be stored in Drug Identification Database 114. The system may be able to compare the shipment information and/or packaging barcodes against the scanned tag code of a medical consumable in order to determine that the correct drug is in the correctly-marked packaging.

The Optical Interference Filter Scanner 104 can also be used by a distributor in the same manner to verify the status of the medical consumable. For instance, the distributor could determine whether a drug has expired, when it was manufactured, or whether it has been recalled by the manufacturer. All of that information can be provided in Drug Identification Database 114 and associated with the tag code of the medical consumable. That information is looked up and provided to the distributor when the medical consumable is scanned. In some embodiments, the system may be able to obtain the medical records or prescriptions for the patient to whom the drug has been prescribed and compare that record against the unique tag code of the medical consumable in order to reduce prescription errors.

In some embodiments, the Optical Interference Filter Scanner 104 may also be used to update Drug Identification Database 114. For example, using the scanning device on a medical consumable may provide for an entry to be recorded in the database as to the location, time, and tag code of the scanned consumable. This allows the chain of possession of medical consumables to be tracked.

A distributor, such as a pharmacist, may also be able to use Optical Interference Filter Scanner 104 and the system in order to perform medication reconciliation by confirming that a medical consumable given to the patient matches what was prescribed to a patient, and that the medication is appropriate for a patient given the patient's medical history. This may be done the same way as described previously. When the pharmacist fills out and validates the prescription for a medical consumable, the pharmacist may scan the medical consumable to make sure that the medication, dose, quantity, and any other pertinent information regarding the medical consumable, matches the prescription provided to the patient. In some embodiments, the system may access Patient-Record Database 112 in order to determine that the drug(s) the patient has been prescribed match that of the identified medical consumable(s). Advantageously, this could be used to reduce the instances of patients obtaining illicit medication using forged prescriptions, since it requires that a prescription be in a patient's records before the medication is distributed to the patient. At this point, other medication errors can be checked for as well, such as ensuring that the prescribed medication is necessary or not harmful given the patient's medical history.

Drug Identification Database 114 is any database that contains information associated with a medical consumable, such as the medication, dose, quantity, expiration date, and so forth, that is indexed using a unique tag code that serves as a reference. Drug Identification Database 114 may reside with the drug manufacturer, the manufacturer of the optical interference filter, or in a public repository. In some embodiments, Drug Identification Database 114 is an electronic database. In other embodiments, Drug Identification Database 114 may be a physical document such as a lookup table that can be consulted manually. Reference tag codes may be generated and assigned using any algorithm. In some embodiments, multiple instances of consumables may be assigned the same unique tag code depending on the algorithm, such as if the consumables have no relevant distinguishing features (e.g., all pills in a bottle may have the same tag code). Generally, the unique tag code will be generated, at least in part, based on a unique signature determined from the energy spectrum associated with the specific optical interference filters that were applied to the corresponding medical consumable by the manufacturer. The unique tag code may also be generated based on characteristics of the filters applied to the medical consumable. Thus, when the medical consumable is scanned using Optical Interference Filter Scanner 104 to obtain a unique scanned tag code, the scanned tag code can be compared against the reference tag codes in the database in order to look up information about the medical consumable.

In some embodiments, the Drug Identification Database 114 may store all the information used in generating the unique tag code. For example, the database may also store characteristics associated with the filters that can be used in looking up information about the medical consumable. Characteristics of the optical interference filters may include a unique signature that can be determined based on interactions with electromagnetic waves, the size or shape of the optical interference filter, the arrangement of the optical interference filters, and so forth.

In some embodiments, Drug Identification Database 114 may include shipping or packaging information associated with the medical consumable, such as barcodes on the packaging. In some embodiments, Drug Identification Database 114 may include the status of the medical consumable, such as recall information, warnings, and instructions issued by the manufacturer.

In some embodiments, the database is a code-to-lot database that records tag codes and the associated drug production lot, or batch, of the medical consumable. A single tag code, or a combination of different tag codes, may correspond to a single drug lot or they may correspond to a number of drug lots. The tag codes and their associated drug lots for may be recorded and maintained by the drug manufacturer. This allows recalls to be performed on specific drug lots, and for any issues (such as inactive medication) to be traced back to specific drug lots for further analysis.

Drug Identification Database 114 may be a single database or multiple databases. For example, there could be multiple drug manufacturers each in charge of maintaining their own database. Alternatively, there may be a single database that is updated by multiple drug manufacturers. A single database may be beneficial since it best enforces a single protocol for database entries. Only one algorithm for generating unique tag codes needs to be used and blocks of unique tag codes can be provided to different drug manufacturers.

Patient-Record Database 112 is a database containing the medical records and/or prescriptions of patients. The system may be able to obtain a list of the current medications that a patient is taking by consulting Patient-Record Database 112. In some embodiments, Patient-Record Database 112 may contain physical medical records and/or prescriptions of patients. In other embodiments, Patient-Record Database 112 is an electronic database containing electronic medical records and/or electronic prescriptions, such as those used by e-prescription services or networks like SureScripts, or any other computer-based electronic system involved in the generation, transmission, and filling of medical prescriptions. A non-limiting example of the types of documents contained within Patient-Record Database 112 is a Continuity of Care Document (CCD) or a similar patient medical document that provides a clinical summary of the patient.

Patient-Record Database 112 may be a single database or multiple databases. For example, there could be a single database that is kept up to date with a patient's medical records. Or there could be various databases containing different portions of a patient's medical history, and all of those databases would need to be accessed in order paint a complete picture of the patient's medical history.

Patient Compliance Appliance 110 is any kind of computing device, software, or platform that facilitates the patient compliance and medication reconciliation processes described within. Patient Compliance Appliance 110 may be the “nerve center” that controls the system for patient compliance and medication reconciliation. Patient Compliance Appliance 110 may serve as the platform that integrates all the various components of the system. In some embodiments, Patient Compliance Appliance 110 may serve as a gatekeeper or middleman to facilitate information exchange between various components of the system. For example, the Optical Interference Filter Scanner 104 might not directly query Drug Identification Database 114 with a unique tag code, but it might instead provide the code to Patient Compliance Appliance 110 to verify. In particular, Patient Compliance Appliance 110 may be pre-configured to obtain information, such as a list of prescribed medications, from various documents or databases containing medical records (e.g., Patient-Record Database 112). In some embodiments, the Patient Compliance Appliance 110 may be configured to reconcile a patient's prescribed medication against the patient's medical history and make a determination of whether a medication error exists.

In some embodiments, the Patient Compliance Appliance 110 may collect the compliance data from patients scanning their medical consumables with Optical Interference Filter Scanner 104. In some embodiments, that patient compliance data can be relayed to an entity (not shown) tasked with monitoring the patient's compliance, for further decisions can be made. For example, the information of a patient's compliance may be relayed to the patient's insurance company, who may decide to reduce the patient's monthly premiums as a reward for compliance. In some embodiments, Patient Compliance Appliance 110 is tasked with communicating with Application 108 on Mobile Device 106 when the patient is tracking their compliance. Patient Compliance Appliance 110 can report any issues that arise during the process for the patient to view on their Mobile Device 108.

In some embodiments, the Patient Compliance Appliance 110 may strip individual identifying information from patient compliance data and aggregate the data. The aggregated patient compliance data may be used for data mining and analysis, such as to determine variables and factors that are useful in predicting the degree of patient compliance a particular individual might exhibit. This knowledge can be used to improve patient compliance, such as by paying more attention and sending more-frequent reminders to individuals at risk of falling out of compliance. Another example use for data mining is to determine when a patient is likely or not likely to comply, in order to turn Scanner 104 on/off remotely. For example, if the patient is very likely to comply, Scanner 104 may not need to always be on and detecting. A number of metadata reports and interactive user interfaces may be generated by Patient Compliance Appliance 110 using the consolidated data using data stripped of patient-identifiable information. For example, a hospital may generate a report of compliance versus drug versus treating physician; the drug company may generate a report summarizing consumption of specific drugs per geographic region or a summary of statistical prevalence of drug combinations.

In some embodiments, the Patient Compliance Appliance 110 may use the patient compliance data to generate a patient compliance report. The patient compliance report can be sent out to health information exchanges, the primary care physician (PCP) or specialty doctors, medical labs, independent health facilities, pharmacies, academic medical centers, community hospitals, the government, insurance companies, and so forth. In some embodiments, Patient Compliance Appliance 110 may provide and generate an interactive user interface for each patient that can be accessible by that patient's physician and insurance. An interactive user interface may also be available for the patient to review their own medication compliance report.

In some embodiments, Application 108 may comprise a Medication Assistant service and Patient Compliance Appliance 110 may be configured to closely interact with the Medication Assistant. In some of such embodiments, Application 108 is a Medication Assistant service that runs on Mobile Device 106, although the Medication Assistant may be configured to run on any electronic device capable of delivering messages to the patient, such as Optical Interference Filter Scanner 104, a phone, a computer, a television, and so forth. The patient may be able to log onto the Medication Assistant with registered credentials. The Medication Assistant may be configured to connect to Patient Compliance Appliance 10, which in some embodiments comprises a Prescription Server. The Prescription Server may securely store prescription information and instructions for a patient. The patient may be able to use the Medication Assistant service to connect to the Prescription Server and obtain available prescription information and instructions, which can be viewed on Mobile Device 106. In some of such embodiments, the Prescription Server may search to see if any active prescriptions are available for the patient.

The Medication Assistant may send real-time feedback and instructions to the patient to remind the patient to take a drug on schedule, as well as guide the patient through the compliance reporting process. For example, the Medication Assistant may issue a visual and audio message telling the patient which drugs need to be taken.

Referring now to FIG. 1B, an illustration is shown of a system comprising Network 102, Mobile Device 106 having Application 108, Patient Compliance Appliance 120 having a Patient-Record Database 122, and Scanner 124 having Drug Identification Database 126. The system of FIG. 1B is similar to the system of FIG. 1A, with the primary differences being that Scanner 124 comprises Drug Identification Database 126 and Patient Compliance Appliance 120 comprises Patient-Record Database 122.

Since Scanner 124 has direct access to Drug Identification Database 126, it can quickly query the database and be used to identify medical consumables, even when it is unable to connect to Network 102. Normally, Scanner 124 may have access to Network 102 either directly or by pairing with Mobile Device 106. However, a patient may attempt to use Scanner 124 where no access to Network 102 is available. Scanner 124 may still be used offline to identify objects using Drug Identification Database 126. Patient compliance data can be saved and uploaded to Patient Compliance Appliance 120 when connection to Network 102 is re-established. However, the drawbacks to this approach are that the Drug Identification Database 126 needs to periodically updated and it is no longer in direct control of the drug manufacturer. If there are multiple drug manufacturers that all maintain their own drug identity database, then Drug Identification Database 126 would need to be updated from all of them. This approach could also be less secure, since the reference tag codes in the database could be compromised and the code generation algorithm reverse-engineered.

Patient Compliance Appliance 120 also has direct access to Patient-Record Database 122, which can serve as a central repository of all relevant patient medical records. Patient Compliance Appliance 120 may be able to store HIPAA-compliant records in Patient-Record Database 122 that have individual identifying information removed. The records may be consolidated and initially pieced together and collected from various databases. Keeping these records in one place that can be quickly accessed by Patient Compliance Appliance 120 allows for speedy reconciliation, which is desirable if it is being performed every time a patient scans a consumable. Since a patient's medical history does not typically change much, other than to be updated with current information, the medical history should not be repeatedly collected from various databases when it only needs to be collected once. This approach gets away from querying many different patient-record databases and reduces the risk that patient health records are somehow exposed or intercepted.

In some embodiments, Patient Compliance Appliance 120 may be configured to create Patient-Record Database 122 by connecting to multiple data sources of federating data to create a longitudinal and consolidated patient record for each patient. This consolidated record may contain, for example, consolidated prescription information across pharmacies, across physicians, and even across geographic boundaries (aka states or nations). Such a record may also consolidate clinical data from home health devices, health information exchanges (HIEs), physician and hospital medical records, as well as other data sources including, but not limited, to state health agencies, laboratories and other clinical sources of data.

The consolidated record may be especially useful in that it can provide a federated view of all prescribed medications for the patient to a human observer, such as pharmacists, physicians, and/or nurses. This complete prescription view allows for medication reconciliation to be easily performed and the creation of an appropriate list of medications that the patient should be able to take. In some embodiments, the federated view may have overlays or additional views that show actual dosing schedules and may have clinical data overlaid. The federated view may allow pharmacists and physicians to manage significantly more patients than they can see physically in a day via home visits. The federated view may also allow physicians or nursing staff who may want to adjust dosing or timing based upon viewing the interrelations of timing and dosing on clinical values. In some embodiments, the pharmacist, physician, nurse, etc. may be able to access and view the consolidated record in Patient-Record Database 112 through Patient Compliance Appliance 110, which is configured to provide the federated view. Thus, Patient Compliance Appliance 110 may be a portal through which they may be able to perform medication reconciliation for the patient.

In some embodiments, the Patient Compliance Appliance 110 may be configured to redact certain information in the consolidated record for HIPAA compliance. For example, certain medications such as psych or HIV medications may need to only be visible to the prescribing doctor in the record.

In some embodiments, the Patient Compliance Appliance 110 may be configured to automatically compare a patient's prescription against the patient's consolidated medical record in order to come up with a recommendation regarding medication reconciliation. Thus, software algorithms can be used to provide the initial review in the medication reconciliation process. This can reduce the work required by a pharmacist, physician, nurse, or other health care professional to constantly monitor the medications taken by a large group of patients. In other embodiments, the entire medication reconciliation process may be performed using software algorithms rather than requiring a pharmacist, physician, nurse, or other health care professional to actively monitor patients.

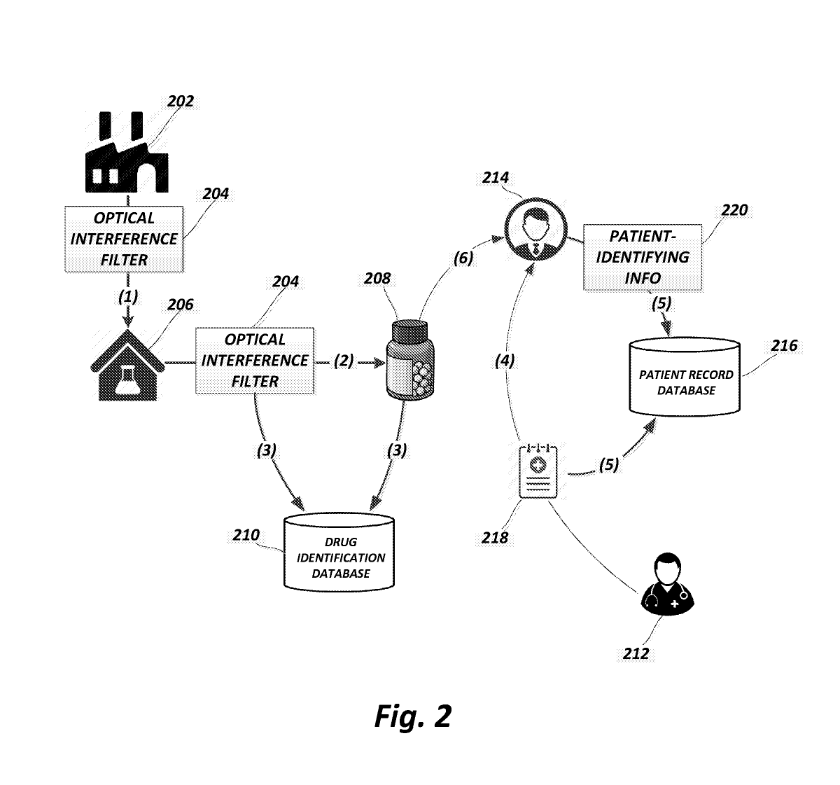

FIG. 2 is a process diagram that illustrates how medical consumables may be provided to a patient according to one embodiment of the system for medication reconciliation and patient compliance.

At arrow (1), OIF Manufacturer 202 provides one or more OIF 204 to Drug Manufacturer 206. As described above, OIF 204 is encoded with a specific, unique signature resulting from the OIF interacting with electromagnetic waves. OIF Manufacturer 202 also provides this unique signature to Drug Manufacturer 206. OIF 204 may also have specific characteristics, such as size, shape, and so forth.

At arrow (2), Drug Manufacturer 206 applies the OIF 204 to Medical Consumable 208. The OIF 204 can be applied in a variety of ways as described previously, such as by being applied to a surface of Consumable 208, incorporated or distributed within the Consumable 208 or a coating of Consumable 208, and so forth. OIF 204 can also be applied in a manner that produces additional identifying characteristics. For example, if there are multiple optical interference filters applied to Consumable 208, they can be arranged on the surface of Consumable 208 in a specific pattern or shape.

At arrows (3), Drug Manufacturer 206 updates Drug Identification Database 210 with information about Consumable 208 and a unique tag code, which is used to index the information about Consumable 208 This reference tag code can be generated using a combination of inputs, such as the unique signature of the OIF 204 or any other identifiable characteristics associated with OIF 204 (e.g., the arranged pattern of the filters). In some embodiments, the tag code may simply be the unique signature. The algorithm used to generate the tag code is important because a scanner device can be used to observe the inputs and regenerate the tag code.

At arrow (4), a Medical Practitioner 212 issues Prescription 218 to Patient 214. Typically, this would be a doctor or nurse prescribing a set of drugs to Patient 214. The doctor or nurse may also provide a drug schedule to Patient 214.

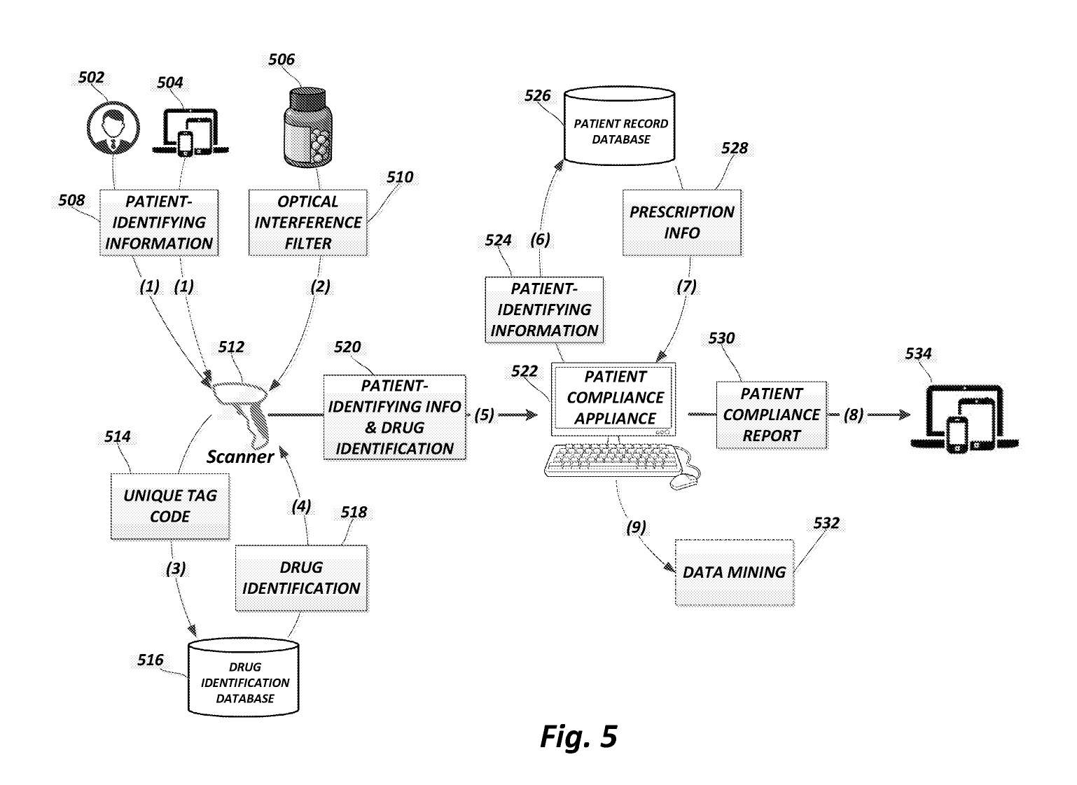

At arrows (5), Prescription 218 and Patient-Identifying Information 220 associated with Patient 214 are provided to Patient-Record Database 216 in order to update the medical record for Patient 214. The importance of this process is elaborated further and shown in FIG. 5.

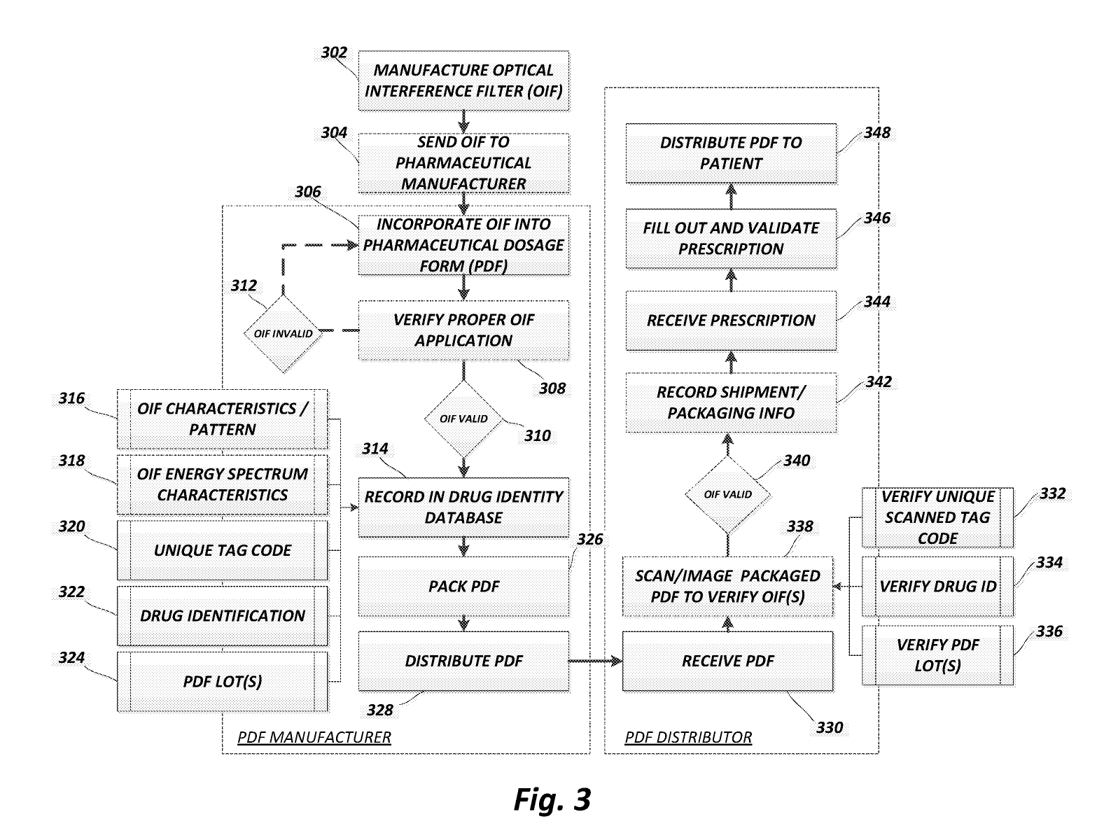

At arrow (6), Consumable 208 that has been tagged with OIF 204 may be distributed to Patient 214. However, before distribution takes place the distributor may wish to validate Prescription 218 to ensure Patient 214 is being given the correct medication. This process is described in further detail in regards to FIG. 3.

FIG. 3 is a block diagram that illustrates how medical consumables may be provided to a patient according to one embodiment of the system for medication reconciliation and patient compliance.

At Block 302, the OIF Manufacturer manufactures the OIF. The OIF Manufacturer carefully selects specific manufacturing input parameters designed to encode the OIF with a unique signature that can later be reproduced.

At Block 304, the OIF Manufacturer sends the OIF to the Pharmaceutical Dosage Form (PDF) Manufacturer. In some embodiments, the pharmaceutical dosage form may be a form of a medical consumable that can be taken in doses in order to provide a therapeutic benefit. The OIF Manufacturer also provides the unique signature of the OIF, as well as any other relevant filter characteristics.

At Block 306, the PDF Manufacturer incorporates the OIF into a desired PDF. In the case of drugs, the PDF Manufacturer may apply the OIF either by coating the exterior of the drug with the OIF, or utilizing the OIF as an ingredient in the drug.

At Block 308, the PDF Manufacturer verifies that the OIF was properly applied to the PDF. In particular, the PDF Manufacturer checks to make sure that the OIF is readable so that a unique signature can be determined. The PDF Manufacturer may also check to make sure that the OIF having the desired unique signature was applied to the PDF. These verifications may be performed using a device capable of scanning or reading the OIF, such as the Optical Interference Filter Scanner 104 as described in FIG. 1.

At Block 312, if the OIF was determined to be invalid, the PDF Manufacturer would have to repeat Block 306 again. It should be noted that a PDF Manufacturer may not be validating every single OIF. The PDF Manufacturer may instead sample a small subset of PDFs in a production lot and make a decision regarding that production lot based on the OIFs of the sampled PDFs.

At Block 310, if the OIF was determined to be valid, then at Block 314 the PDF Manufacturer may add or record an entry in a drug identity database. The entry may include information such as OIF Characteristics/Patterns 316, OIF Energy Spectrum Characteristics 318 used to determine a unique signature (or the unique signature itself), Unique Tag Code 320 used to index the entry in the database, Drug Identification Information 322, and PDF Lot Information 324. The PDF Manufacturer may first have to generate or determine the Unique Tag Code 320. Different PDF Manufacturers may determine Unique Tag Code 320 in different ways, or they may be encouraged to determine Unique Tag Code 320 the same way. In some embodiments, all of the possible unique tag codes are determined by the OIF Manufacturer, and blocks or ranges of unique tag codes may be provided to the PDF Manufacturer in advance.

At Block 326, the PDF Manufacturer may package the PDF. The package may have shipment information, a packaging label or barcode, and so forth. In some embodiments, a OIF is applied directly to the packaging so that information about the contents of the packaging and the manufacturer can be determined through scanning rather than needing the package to be opened.

At Block 328, the PDF Manufacturer may distribute the PDF to a PDF Distributor, such as a pharmacy. It should be noted that PDF Distributors or pharmacies may perform any of the Blocks described up to this point. In other words, pharmacies or distributors may undertake any of the roles of the OIF Manufacturers and PDF Manufacturers, including but not limited to, manufacturing OIFs, shipping OIFs, applying OIFs to medical consumables, scanning and verifying tagged consumables, recording code-to-lot values in a database, and packaging the tagged consumables.

At Block 330, the PDF Distributor receives the packaged PDF.

At Block 338, the PDF Distributor can use a scanner device to scan or image the PDFs in the package in order to verify their unique scanned tag code 332, verify the drug identification 334, and/or verify the production lot 336 of the PDFs against what the package states. In other words, the PDFs are compared against the shipment/packaging information to determine that the correct drug is in the correctly-marked packaging. The scanner device may complement “traditional” means of identifying drugs or consumables in order to provide an additional layer of security, delivering a higher confidence level of a correct and authentic drug.

In some embodiments, packaging information may be determined using the scanner device if the package has an OIF. The devices described herein may be used to scan the package and lookup information associated with the package, such as the contents of the package, the manufacturer, the recipient, and so forth. In some embodiments, there may be a separate database with entries that pertain solely to OIFs used with packages, and the packaging information can be stored there. In other embodiments, the information associated with the packages can be stored alongside entries of drug identities in the same database. The database entries for the package may index or reference the PDFs inside that specific package.

In other embodiments, there may be available shipping information, the package may be adequately labeled, or the package may have a barcode. In some embodiments, the scanning device may also be able to directly scan the barcode and obtain packaging information that way. In some embodiments, a user of the scanning device—in this case a pharmacist—may be able to manually enter shipping or packaging codes into the device to obtain packaging information.

In some embodiments however, the PDFs need not be packaged and can be provided in loose form. Alternatively, the PDFs can be provided in transparent blister packs. In either of these cases, the PDF Distributor may directly scan all of the PDFs, or a statistical sample of the PDFs. The scanning device may be able to record the location, time, and tag code of the scanned PDFs in order to track the possession of PDFs after they have left the PDF Manufacturer. In some embodiments, that information may be entered into a database.

At Block 340, if the OIF of the PDF is valid, such as if the PDF was in the correct packaging, then at Block 342 the shipment and packaging information may be recorded, along with the location, time, and tag code of the scanned PDFs in order to track the possession of PDFs after they have left the PDF Manufacturer. In some embodiments, all of this information may be entered in a database to refer back to later if any issues arrive.

At Block 344, the PDF Distributor is sent a prescription for a patient who is seeking to get their prescription filled by the PDF Distributor. At this point, the patient's electronic record, such as that stored in Patient-Record Database 112, could already be updated with the new prescription.

A Block 346, the PDF Distributor may fill out and validate the prescription. The patient's information may be entered into a Prescription Assurance system. In some embodiments, the Patient Compliance Appliance 110 may comprise the Prescription Assurance System. The Prescription Assurance system may then obtain the patient's medical record, such as by accessing Patient-Record Database 112. In some embodiments, the patient's medical record is an electronic medical record that includes prescription information. A OIF scanning device is then used to scan the OIF on each individual PDF to be provided in the prescription. In some embodiments, loose pills can be either manually loaded into the scanner, or the batch of pills can be inserted into a pill loader which auto loads the pills into the scanner. The scanner may look up information for each PDF, such as medication, manufacturer, dosage, and expiry date, and validate the PDF against patient's record. This can be used to help avoid or reduce prescription errors with a high level of granularity since each individual PDF is being scanned.

If there are any discrepancies, the pharmacist at the pharmacy is alerted and a scan transaction may be stripped of patient-specific data and uploaded to the drug manufacturers' server, allowing the drug manufacturer to track drug distribution in the channel as well as possible illegal diversions. If there are no discrepancies, dosage information is printed on a drug bag or cartridge and guidance provided as needed to the patient. Prescription information is securely uploaded to, and stored on, a web-based Prescription Server. In some embodiments, the Patient Compliance Appliance 110 comprises the Prescription Server. The prescription information may also be loaded onto a Medication Assistant service that the patient is registered with, or it may be directly loaded on the patient's scanning device, which could be a pillbox.

At Block 348, the PDFs are then distributed to the patient.

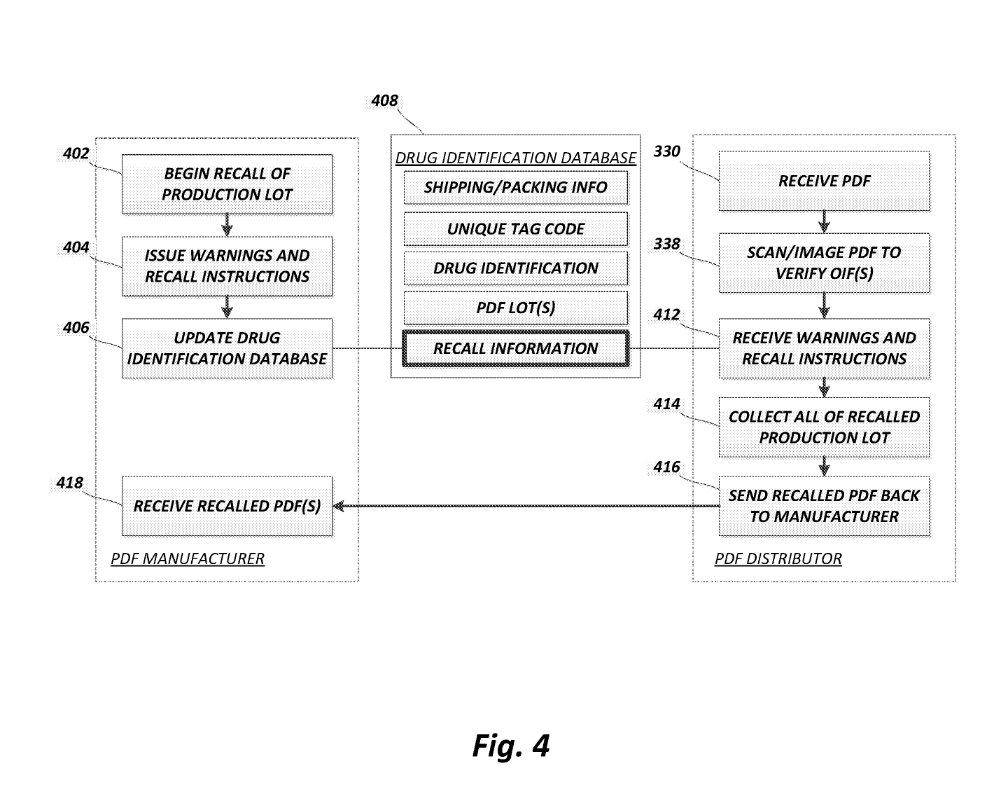

FIG. 4 is a block diagram that illustrates how medical consumables may be recalled according to one embodiment of the system for medication reconciliation and patient compliance.

Blocks 330 and 338 may be performed by a PDF Distributor and were previously discussed in regards to FIG. 3.

At Block 402, the PDF Manufacturer may decide to begin recall of a specific drug production lot.

At Block 404, the PDF Manufacturer may then create warnings and recall instructions, and then issue said warnings and recall instructions, such as at Block 406, at which the Drug Identification Database 408 may be updated. More specifically, the recall information can be added to the entries corresponding to the recalled production lot.

At Block 412, the PDF Distributor will have already scanned the drugs in the recalled production lot using a tag scanning device. The unique tag codes associated with the OIFs of those drugs will allow looking up the entries containing recall information for the recalled drugs in Drug Identification Database 408. The PDF Distributor will then receive the warnings and recall instructions issued by the manufacturer and entered into the database. In other words, when affected pills are scanned (by distributor, pharmacist, patient, etc.), a warning message alerts of the recall and instructs what to do.

At Block 414, the PDF Distributor may collect all of the recalled production lot in their inventory. Thus, the PDF Distributor may have to scan many drugs to determine which ones are affected with the recall.

At Block 416, the PDF Distributor may send all of the recalled drugs back to the manufacturer.

At Block 418, the PDF manufacturer receives the recalled drugs for verification, accountability, handling, and disposal, as applicable.

FIG. 5 is a process diagram that illustrates how patient compliance with medical consumables can be tracked and monitored according to one embodiment of the system for medication reconciliation and patient compliance.

At arrow (1), Patient 502 provides patient-identifying information 508 to Scanner 512. In some embodiments, Patient 502 provides Patient-Identifying Information 508 by entering it through Mobile Device 104. In some embodiments, Patient-Identifying Information 508 may comprise prescription information or the identity of the drug about to be consumed.

In some embodiments, the Medication Assistant service is available and may be utilized, such as through Mobile Device 104 or Scanner 512. Patient 502 may log in to the Medication Assistant with registered credentials, which may be the Patient-Identifying Information 508 in some cases. The Medication Assistant can then pull up the user profile associated with Patient 502, and it may then search for active prescriptions for Patient 502 by connecting to a Prescription Server using a web connection or searching through internal memory.

At arrow (2), Patient 502 may scan various Medical Consumables 506 tagged with OIF 510 using Scanner 512. In the case where Medical Consumables 506 comprise pills, in some embodiments, Patient 502 may have to scan one pill at a time in Scanner 512, and in some of such embodiments, the Patient 502 may need to manually load each pill into Scanner 512 one at a time. In some embodiments, Patient 502 may be able to load all of the pills to be taken at once in a multi-pill loader for Scanner 512 to scan. In some embodiments, Patient 502 may be able to insert a pre-loaded cartridge of pills into Scanner 512. Each pill is scanned.

At arrow (3), Scanner 512 scans the pill to receive an energy spectrum associated with the OIF 510 used to tag the pill. The energy spectrum characteristics and spectrum features are used, along with any other relevant identifiable characteristics of OIF 510, to generate Unique Scanned Tag Code 514. The Scanner 512 may use the Unique Scanned Tag Code 514 to query Drug Identification Database 516. The Drug Identification Database 516 can be located on a web server, or in some embodiments it can be integrated with Scanner 512.

At arrow (4), assuming that the Unique Scanned Tag Code 514 has a matching reference tag code in Drug Identification Database 516, the Drug Identification Database 516 will find any information associated with the tag code. The information may include Drug Identification Info 518, such as medication, dosage, expiration, and so forth. The Drug Identification Info 518 is then returned to Scanner 512.

At arrow (5), Scanner 512 may send Patient Identifying Information & Drug Identification information 520 to Patient Compliance Appliance 522.

At arrow (6), Patient Compliance Appliance 522 may use the Patient-Identifying Information 524 to query Patient Record Database 526, which contains the medical records for Patient 502. In some embodiments, Patient Record Database 526 is an electronic database containing electronic medical records.

At arrow (7), Prescription Information 528 is returned back to Patient Compliance Appliance 522. In some embodiments, Prescription Information 528 is electronic prescription information. Patient Compliance Appliance 522 compares the prescription information to the drug identification information from the pill to see if there is a match.

In some embodiments, an audio and or visual signal is provided by the Medication Assistant to Patient 502 for each pill which was scanned correctly and was validated against the prescription. Optionally, this signal is generated once all the pills have been scanned. Optionally, an image of each scanned pill is displayed from a code-image database, which can be stored on Scanner 512 or in Drug Identification Database 516. In case a discrepancy is found (wrong pill, dosage, expired, source invalidated), the Medication Assistant may display a message or produce an audio message with instructions for Patient 502 while alerting the prescribing physician and/or pharmacist. In some embodiments, any alerts (whether to the patient, physician, others) may be sent and displayed on electronic personal communication devices. Some non-limiting examples of such devices include mobile phones, tablets, laptops, desktop PCs, and wearable devices.

In some embodiments, a scan log is produced. The scan log can be held with Patient Compliance Appliance 522, or Patient Compliance Appliance 522 updates the scan log to Patient 502's electronic record in Patient Record Database 526. In some of such embodiments, if a scan log is not received by the in Patient Record Database 526 within a predefined time of a scheduled prescription, the doctor's office is alerted and may contact Patient 502. In some embodiments, the scan log may be held by Patient Compliance Appliance 522. In some embodiments, the scan log may be used as evidence of the scanned number of pills. The Patient Compliance Appliance 522 will keep a tab on the number of pills prescribed to Patient 502 versus a total number of scanned tags by Patient 502. An alert message may be generated and sent to the patient and pharmacy before a prescription needs to be re-filled. The alert may be calculated based on the lead time to order each medication to ensure a Just in Time delivery. Keeping track of the scanned number of pills may also allow the identification of errors, such as instances when there is a greater number of scanned tags than pills prescribed to the patient.

If Patient 502 received prescriptions from multiple doctors, a drug interaction test may be performed directly by Scanner 512 or by Patient Compliance Appliance 522 to ensure no hazardous drug combinations were scanned. If there are hazardous or other contraindicative combinations, an alert can be generated on the Medication Assistant and the respective physicians are notified.

In some embodiments, after a patient scans the pill, dosing information may appear on a display of Scanner 512, on a display on the Patient's electronic personal communication device such as the Patient's mobile phone, or through the Medication Assistant service. This dosing information may be extracted from the patient's electronic record. For example, if a pill is supposed to be taken with a meal, that information may be displayed on the Medication Assistant screen.

At arrow (8), a Patient Compliance Report 530 may be generated and sent to a Computing Device 534 to be viewed.

At arrow (9), Patient Compliance Appliance 522 may use patient compliance data aggregated across many patients in order to perform Data Mining 532.

In some embodiments, the Patient Compliance Appliance 522 may also be able to assess Patient 502's compliance data over time in order to provide incentives for further compliance. In some embodiments, Patient Compliance Appliance 522 may be able to initiate an incentive program by entering Patient 502 into lotteries or issuing prizes to Patient 502 as a reward to encourage regular medication ingestion and timely medication setup. In some embodiments, the incentive program may be initiated by the stakeholders (hospital, insurance company, doctor, etc.) to motivate scanning of medication. For example, after a number of scans have been performed, a reward such as a coupon may be sent to the patient's cellphone.

In some of such embodiments, prizes may be determined based on information known about Patient 502, such as information in the user profile or the patient's medical records. For example, Patient Compliance Appliance 522 may be able to avoid issuing candy to diabetics or restaurant gift cards to patients with eating disorders. In some embodiments, different levels of prizes can be unlocked or awarded for different levels or forms of compliance. For example, Patient Compliance Appliance 522 may be able to take into consideration factors such as timely dosing, multiple daily dose compliance, dose accuracy, the rapid adoption of new medications, and so forth in evaluating the prize to be awarded.

In some embodiments, the prizes and tiers may be shown to Patient 502. For example, they may be disclosed through Medication Assistant, through some kind of custom application on Mobile Device 504, or through a webpage associated with the lottery/prize structure.

In some embodiments, the lottery/prize enrollment process performed by Patient Compliance Appliance 522 may have an additional step of validating that Patient 502 has ingested the Medical Consumables 506. For example, Patient 502 may be requested to provide photos that show him/her inserting pills into their mouth via the camera on Mobile Device 504.

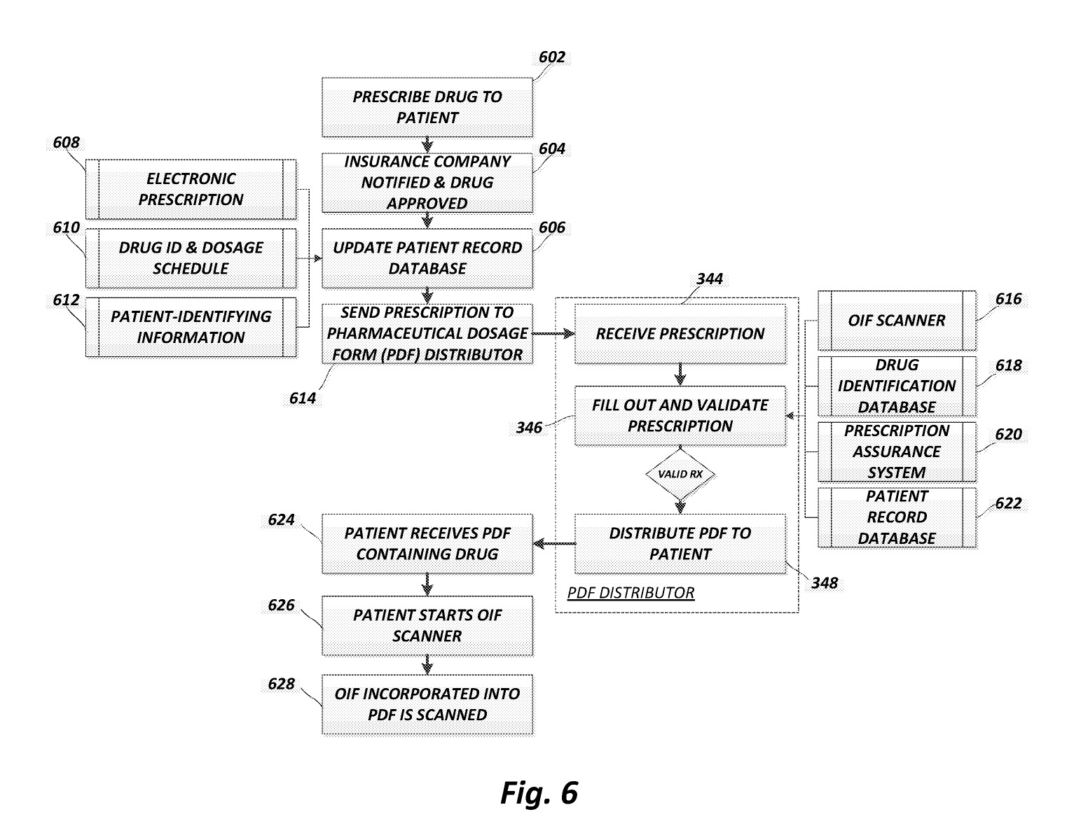

FIG. 6 is a block diagram that illustrates how medication reconciliation provides patients the correct medical consumable according to one embodiment of the system for medication reconciliation and patient compliance.

The diagram illustrates some of the blocks already described in FIG. 3, such as Blocks 344, 346, and 348.

At Block 602, a drug is initially prescribed to a patient by a health care professional. In some embodiments, the health care professional may enter prescription details in Patient Compliance Appliance 110.

At Block 604, the patient's insurance company may be electronically notified and the prescribed drug may be approved.

At Block 606, the patient record database is updated. In some embodiments, Patient Compliance Appliance 110 updates the database as soon as the prescription is approved. The updates may include the Electronic Prescription 608, Drug Identification Info & Dosage Schedule 610, and Patient-Identifying Information 612 that can be used to look up the prescription.

At Block 614, the prescription from the database is sent to the PDF Distributor in response to the PDF Distributor receiving a request to fill the prescription from the client. Then, at Block 346, the patient's prescription may be validated using information obtained from OIF Scanner 616, Drug Identification Database 618, Prescription Assurance System 620, and Patient Record Database 622.

At Block 348, the PDF or drug is distributed to the patient.

At Block 624, the patient receives the drug from the PDF Distributor. The patient may also be provided with prescription information, such as a dosage schedule, that can be accessed and viewed through a Medication Assistant service by the patient.

At Block 626, the patient may be about to consume the drug and will provide compliance evidence using a OIF scanner. The OIF scanner used by the patient at Block 626 may be different than the OIF Scanner 616. For example, the OIF scanner used by the patient may be a device designed for home use. In some embodiments, such a home detector can comprise a pillbox integrated with a tag reader for scanning the contents of the pillbox, in order to read the tags on, or in, a pill. In other embodiments, the home detector may be a handheld device. In yet other embodiments, the home detector may comprise a toilet with a tag reader or sensor that may be able to analyze OIFs after they have passed through the patient and into the toilet.

At Block 628, the OIFs in the drug are scanned using the methods previously described herein.

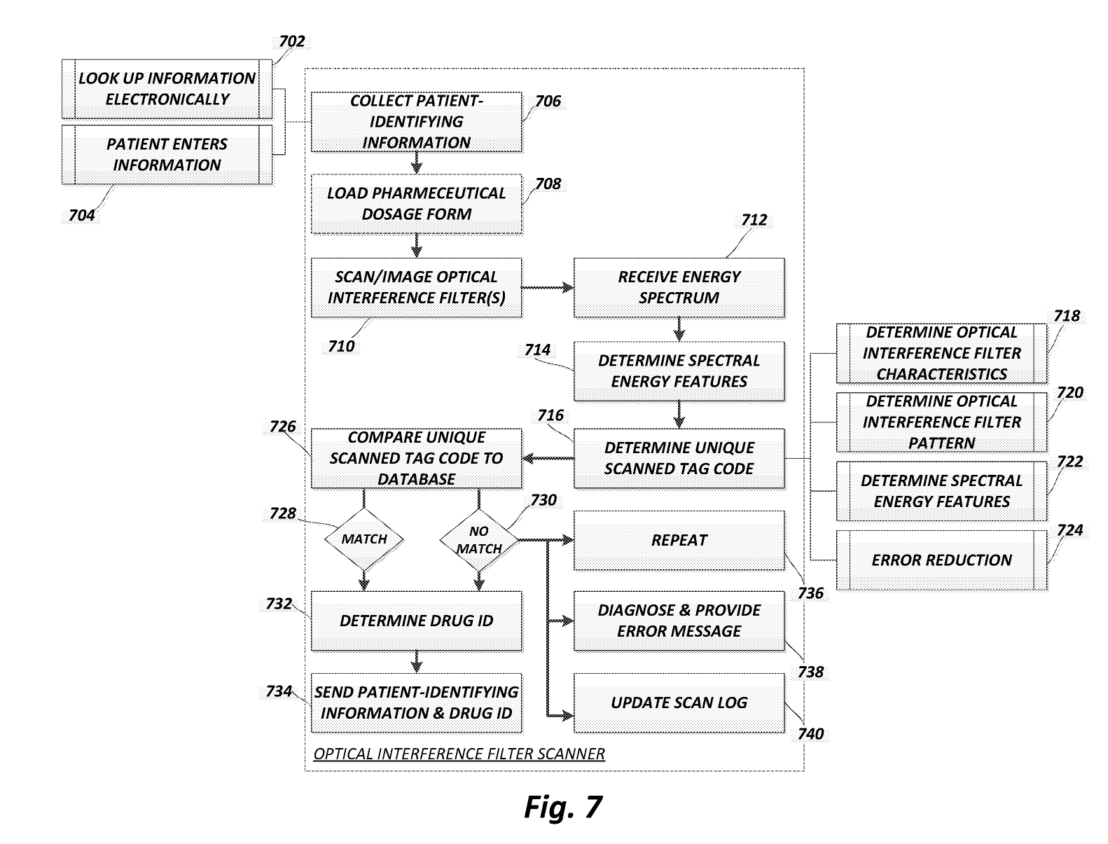

FIG. 7 is a block diagram that illustrates how a patient uses a device to monitor and report compliance according to one embodiment of the system for medication reconciliation and patient compliance. In particular, the functions of one embodiment of an OIF Scanner are shown, and this figure may provide more context to the process described in FIG. 5

At Block 706, the OIF Scanner collects patient-identifying information. This may be done through a variety of ways, such as at Block 702 by looking up information electronically. An example of this is if the patient's profile is stored within the OIF Scanner or stored online. Alternatively, at Block 704 the patient enters or provides information that can be used to identify the patient. For example, the patient may scan their prescription or prescription bottle, enter credentials for their profile, and so forth.

At Block 708, the patient loads the pharmaceutical dosage form into the OIF Scanner. As previously mentioned, this may involve manually loading the PDF, a cartridge with the PDF, and so forth.

At Block 710, the OIF Scanner will scan and/or image the PDF.

Scanning may involve emitting an electromagnetic wave at the PDF. Imaging the OIFs may be a step in determining certain characteristics associated with the OIFs.

At Block 712, the OIF Scanner receives an energy spectrum, which is based on how the electromagnetic wave interacts with the OIF.

At Block 714, the OIF Scanner may determine spectral energy features from the energy spectrum. As mentioned previously, this may include the position of peaks in the energy spectrum, side lobes, and so forth.

At Block 716, the OIF Scanner will determine the unique scanned tag code associated with the OIFs on the scanned PDF. This determination may be programmed into OIF Scanner and can involve a variety of inputs. For instance, at Block 718 the OIF Scanner may determine OIF characteristics. These characteristics may be determined from imaging the OIFs to determine attributes of an individual OIF such as size and shape. At Block 720, the OIF Scanner may determine OIF patterns, arrangements, and so forth. For example, the OIF Scanner may use the image to determine how OIFs are patterned or arranged on the surface of the PDF. For instance, the OIF Scanner may use image recognition and analysis, such as by using known machine learning techniques, in order to determine pattern and arrangement within an acceptable degree of error. At Block 722, the OIF Scanner may use determined spectral energy features as an input in some manner. For example, the OIF Scanner may determine the positions of all the peaks in the energy spectrum and convert them into some kind of unique signature, code, hash value, or so forth. At Block 724, the OIF Scanner may also perform error reduction on the previously mentioned inputs in order reduce the effect of small variations between OIFs on a PDF, or to account for OIFs that may been moved or disturbed. Not all of these inputs need to be used. In some embodiments, using the spectral energy features to determine a unique signature may be all that is needed to determine a unique scanned tag code. Using additional inputs may increase the number of unique tag codes at the expense of reduced accuracy in reproducing the correct tag code.

At Block 726, the OIF Scanner compares the unique scanned tag code against a database having entries that are indexed with reference tag codes. This lets the unique scanned tag code be used for looking up database entries that fit the unique scanned tag code.

At Block 730, if the unique scanned tag code does not match a reference tag code in the database, at Block 736, the patient may have to repeat the scanning and try again. At Block 738, the OIF Scanner may attempt to diagnose the error while providing an error message to the patient. For example, if the error is potentially the result of the receiver of the electromagnetic wave being obscured or faulty, then the patient may be informed to check placement of the PDF and try again. At Block 740, the OIF Scanner may also update the scan log with the error.

At Block 728, if the unique scanned tag code matches a reference tag code in the database that means an entry exists for the unique scanned tag code. The entry will typically have information relevant to the object that has been tagged, which in this case is a PDF, so the entry may have drug identification, manufacturer and manufacture date, expiration, dosage, and so forth.

At Block 732, the OIF Scanner will attempt to determine the drug identification from the entry. In some cases, the OIF Scanner may receive the entire matching entry from the database, while in other cases the OIF Scanner may receive only part of the entry, such as the drug identification.

At Block 734, the OIF Scanner will send the patient-identifying information and drug identification to a patient compliance appliance or platform.

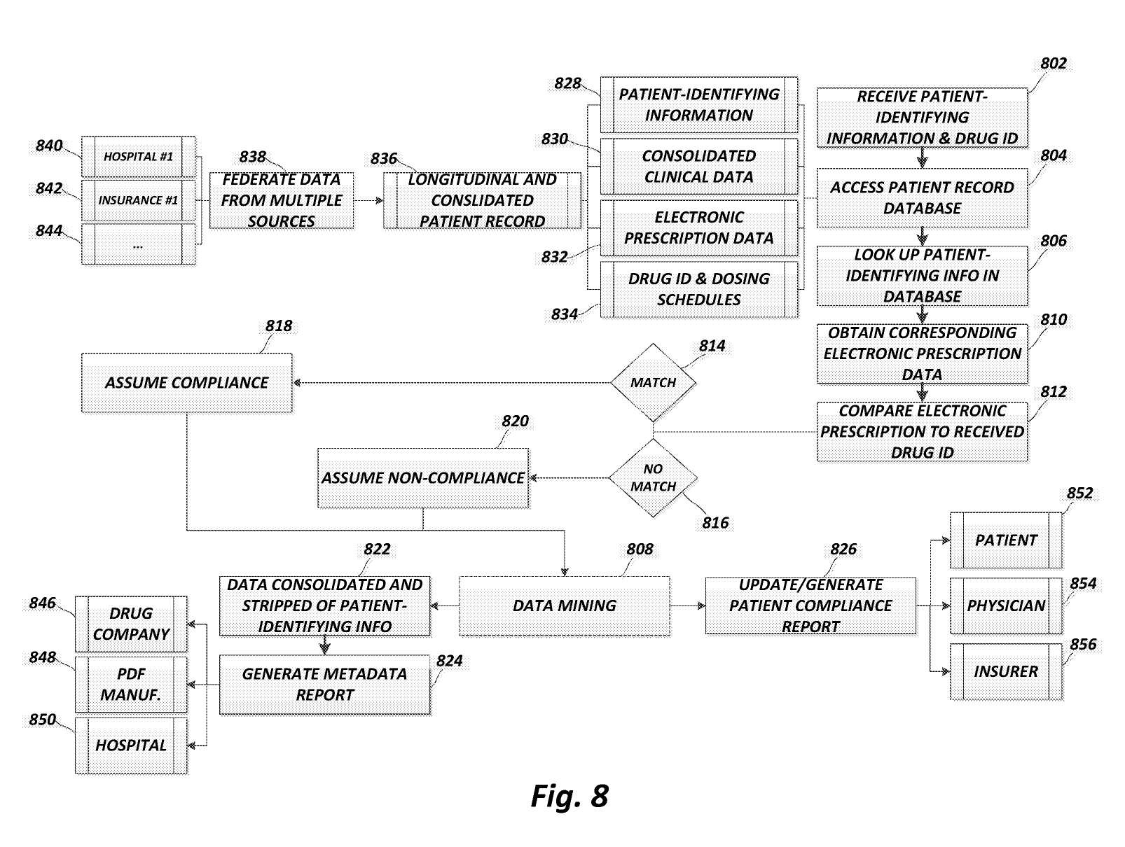

FIG. 8 illustrates a block diagram that illustrates how patient compliance with medical consumables can be tracked according to one embodiment of the system for medication reconciliation and patient compliance. The figure is from the perspective of the patient compliance appliance or platform.

At Block 802, the patient compliance appliance receives patient-identifying information and a drug identification from the scanner, as described in regards to Block 734. It should be noted that there may be one or more drug identifications if the patient is taking multiple drugs. The scanner may have been configured to scan multiple PDFs and determine the drug identification of each.

At Block 804, the patient compliance appliance may access the patient record database. The patient record database may include varying types of information for the patient, such as Patient-Identifying Information 828, Consolidated Clinical Data 830, Electronic Prescription Data 832, and Drug ID & Dosing Schedules 834.

In some embodiments, all of that information for the patient may be stored in a singular, Longitudinal and Consolidated Patient Record 836, so that the patient compliance appliance does not need to go through records held by various databases and data sources in order to obtain the full record for the patient. The Longitudinal and Consolidated Patient Record 836 may have been composed at Block 838 by federating data from multiple sources, such as Hospitals 840, Insurance Companies 842, and any other source 844.

At Block 806, the patient compliance appliance may attempt to use the received patient-identifying information to look up records for that patient in the database.

At Block 810, the patient compliance appliance may obtain the electronic prescription data for the patient, which may include drug identification and dosing schedules for the prescription.

At Block 812, the patient compliance appliance may compare the electronic prescription data to the drug identifications obtained from scanning. At Block 814, if there is a match then at Block 818 patient compliance may be assumed. At Block 816, if there is no match then at Block 820 non-compliance may be assumed.

At Block 808, the compliance data may be stored by the patient compliance appliance for data mining. For instance, at Block 826, the patient compliance appliance may use the compliance data for a given patient over a certain timeframe to update or generate a patient compliance report. That patient compliance report can be sent to the patient 852, the patient's physician 852, and the patient's insurer 856 as well as any other party.

Additionally, at Block 822 the patient compliance data across all patients may be consolidated and stripped of patient-identifying information. The patient compliance data may have non-identifying information, such as age, gender, general location, income, and so forth. At Block 824, this consolidated information can be analyzed using well-known data analysis techniques, such as by performing a regression, and used to generate a metadata report. The metadata report can be sent to Drug Company 846, PDF Manufacturer 848, Hospital 850, and any other party.

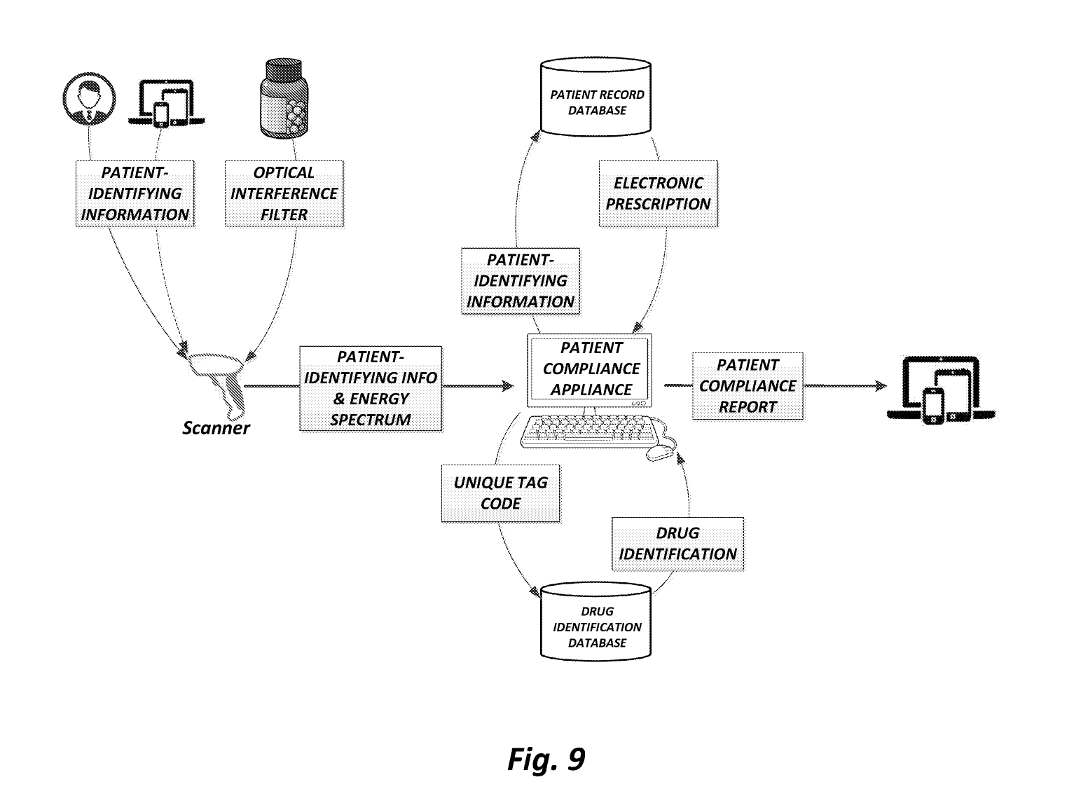

FIG. 9 is a process diagram that illustrates how patient compliance with medical consumables can be tracked according to one embodiment of the system for medication reconciliation and patient compliance.

FIG. 9 is very similar to FIG. 5. The primary difference between the embodiment shown in FIG. 9 and that shown in FIG. 5 is that, in FIG. 9, the scanner does not determine a unique scanned tag code and obtain a drug identification from the identification database. Instead, the scanner just sends the patient identifying information and energy spectrum to the patient compliance appliance. The patient compliance appliance then generates the unique tag code and uses it to query the drug identification from the identification database.

The primary benefit to this approach is that the scanner is kept in the dark regarding all aspects of unique tag code generation. This reduces the likelihood that someone could reverse-engineer the unique tag code generation algorithm, or the possibility of someone being able to “spoof” tag codes by reprogramming the scanner to send a certain tag code, and is a step towards preserving the integrity of any incentive program.

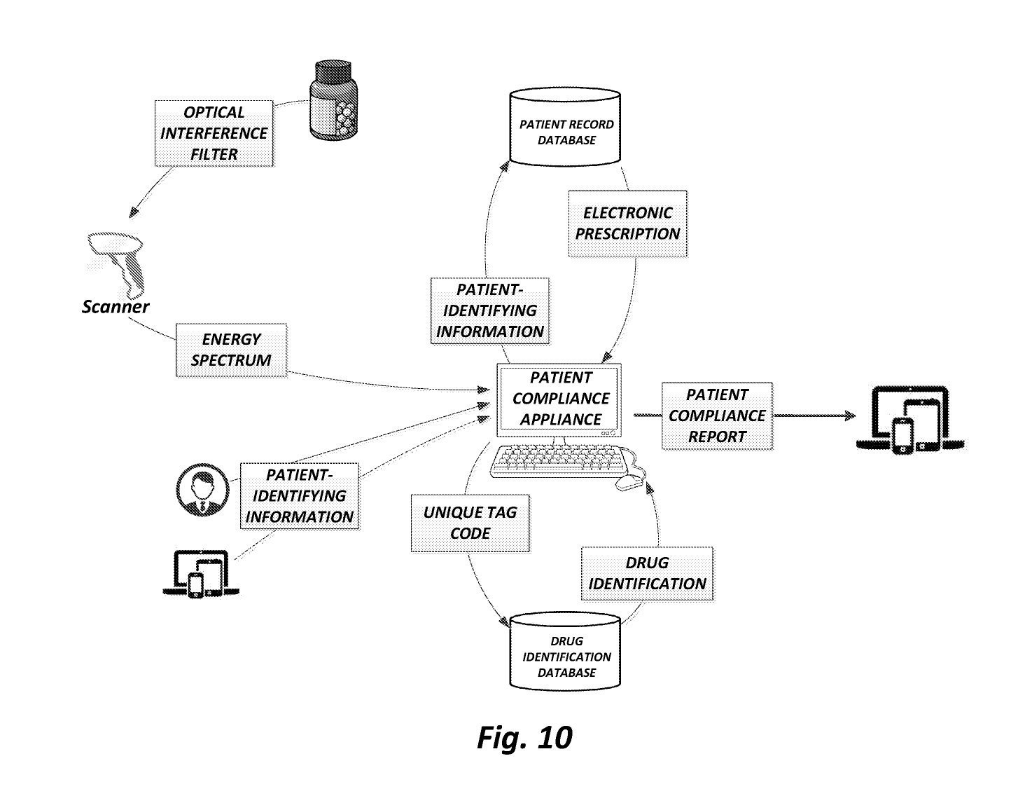

FIG. 10 is a process diagram that illustrates how patient compliance with medical consumables can be tracked according to one embodiment of the system for medication reconciliation and patient compliance.

FIG. 10 is very similar to FIG. 9. The primary difference between the embodiment shown in FIG. 10 and that shown in FIG. 9 is that FIG. 10 takes it even further by having the patient directly submit patient-identifying information to the patient compliance appliance rather than providing it to the scanner. For instance, if the scanner is a pillbox it may not have a user interface for receiving user inputs or patient-identifying information. The patient may submit the patient identifying information directly to the patient compliance appliance.

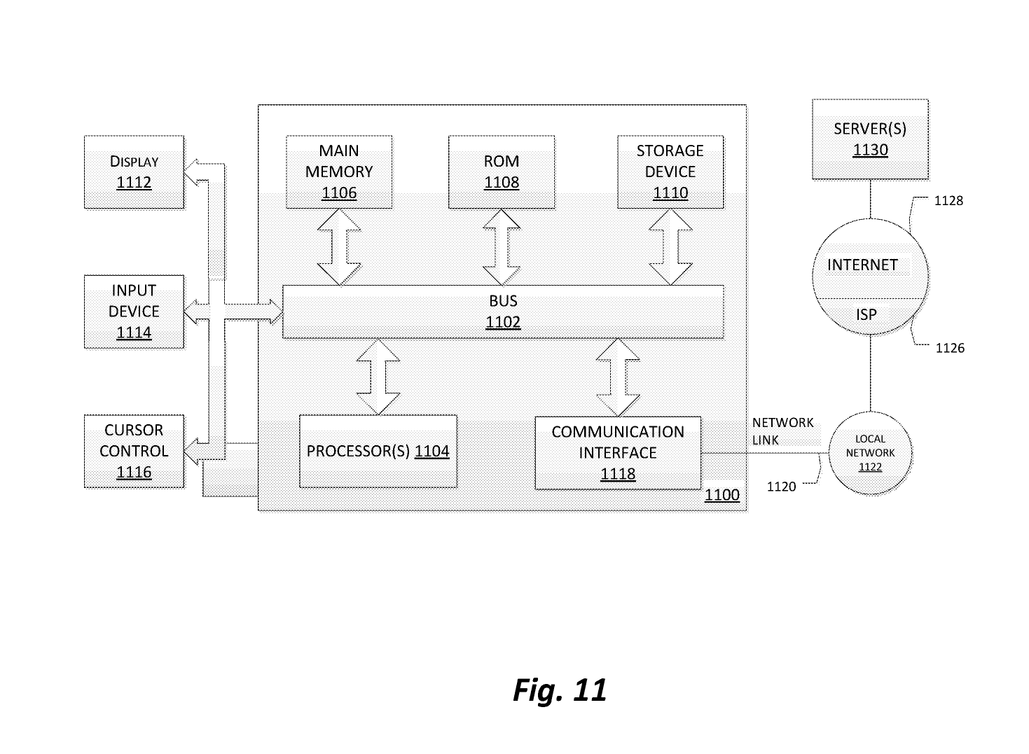

FIG. 11 illustrates an example computer system in which one embodiment of the system for medication reconciliation and patient compliance may be implemented. For example, any of the computing devices discussed herein, such as the appliance or any client computing devices may include some or all of the components and/or functionality of the computer system 1100.

Computer system 1100 includes a bus 1102 or other communication mechanism for communicating information, and a hardware processor, or multiple processors, 1104 coupled with bus 1102 for processing information. Hardware processor(s) 1104 may be, for example, one or more general purpose microprocessors.

Computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1402 for storing information and instructions.

Computer system 1100 may be coupled via bus 1102 to a display 1112, such as a cathode ray tube (CRT) or LCD display (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to hardware processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between nontransitory media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid state drive of a remote computer. The remote computer can load the instructions into its dynamic memory and send the instructions over a telephone line using a modem or other network interface, such as a WAN or LAN interface. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may retrieve and execute the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN (or WAN component to communicated with a WAN). Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

What is claimed is:

1. A non-transitory computer readable medium storing a program, the program causing a computer to:
receive patient-identifying information associated with a patient;
receive a drug identification associated with a pharmaceutical dosage form associated with an optical interference filter, wherein the drug identification is obtained by:
scanning the optical interference filter associated with the pharmaceutical dosage form via an emitter configured to emit an electromagnetic wave;
receiving an energy spectrum associated with the optical interference filter via a receiver configured to receive the energy spectrum, wherein the energy spectrum is based on the electromagnetic wave interacting with the optical interference filter;
determining one or more spectral energy features from the energy spectrum;
determining a unique scanned tag code based on the characteristics of the one or more spectral energy features from the energy spectrum, wherein the unique scanned tag code is associated with the optical interference filter associated with the pharmaceutical dosage form;
comparing the unique scanned tag code to a database containing the drug identification in order to determine a match; and
upon determining the match, determining the drug identification associated with the unique scanned tag code and the optical interference filter;
access a patient-record database containing an electronic prescription associated with the patient;
determine the electronic prescription associated with the patient based on the received patient-identifying information associated with the patient;
compare the received drug identification to the electronic prescription associated with the patient to determine patient compliance; and
generate or update a patient compliance report based on the determined patient compliance.

2. The non-transitory computer readable medium of claim 1, wherein the pharmaceutical dosage form comprises a solid, semi-solid, or liquid dosage form.

3. The non-transitory computer readable medium of claim 1, wherein the pharmaceutical dosage form is a solid or semi-solid oral dosage form that comprises pills, tablets, capsules, gel caps, caplets, powders, crystals, thin-films, or other orally-consumable forms of medication.

4. The non-transitory computer readable medium of claim 1, wherein the pharmaceutical dosage form is a liquid dosage form that comprises creams, gels, liniments, balms, lotions, injectable solutions and mixtures, ointments, or other liquid forms of medication.

5. The non-transitory computer readable medium of claim 1, wherein the pharmaceutical dosage form is coated with, or otherwise incorporated with, the optical interference filter associated with the pharmaceutical dosage form.

6. The non-transitory computer readable medium of claim 1, wherein the optical interference filter associated with the pharmaceutical dosage form is added into an outer coating of the pharmaceutical dosage form, distributed on the outer layer of an uncoated pharmaceutical dosage form, and/or distributed throughout the pharmaceutical dosage form.

7. The non-transitory computer readable medium of claim 1, wherein the optical interference filter associated with the pharmaceutical dosage form is incorporated within the pharmaceutical dosage form.

8. The non-transitory computer readable medium of claim 1, wherein the electromagnetic wave may have a wavelength in the visible spectral range from 390 to 750 nm.

9. The non-transitory computer readable medium of claim 1, wherein the energy spectrum may include, but is not limited to, the visible spectral range from 390 to 750 nm.

10. The non-transitory computer readable medium of claim 1, wherein the optical interference filter comprises a layered Bragg-like filter.

11. The non-transitory computer readable medium of claim 1, wherein the optical interference filter comprises a rugate filter.

12. The non-transitory computer readable medium of claim 1, wherein the optical interference filter comprises a rugate microtag, wherein the rugate microtag is a rugate filter made of porous silicon, a rugate filter made of porous silica, or a rugate filter having varying proportions of both porous silicon and porous silica.

13. The non-transitory computer readable medium of claim 12, wherein each spectral energy feature in the one or more spectral energy features is a rugate spectral peak in the received energy spectrum of the rugate microtag, wherein each rugate spectral peak is associated with a different sinusoidal component of an electrochemical etching waveform used to manufacture the rugate microtag.

14. The non-transitory computer readable medium of claim 13, wherein the characteristics of the one or more spectral energy features used to determine the unique scanned tag code are associated with the different sinusoidal components of the electrochemical etching waveform.

15. The non-transitory computer readable medium of claim 1, wherein the optical interference filter has a characterized shape, and wherein the unique scanned tag code is further determined based on the shape of the optical interference filter.

16. The non-transitory computer readable medium of claim 1, wherein the optical interference filter comprises one or more rugate microtags, wherein the one or more rugate microtags are arranged in a pattern detectable using an imaging device, and wherein the unique scanned tag code is further determined based on the pattern of the one or more rugate microtags.

17. The non-transitory computer readable medium of claim 16, wherein the pattern of the one or more rugate microtags comprises a geometric shape or a bar code.

18. The non-transitory computer readable medium of claim 1, wherein the program stored on the non-transitory computer readable medium is further configured to cause a computer to alert a patient or a doctor based on the comparison of the received drug identification to the electronic prescription associated with the patient.

19. The non-transitory computer readable medium of claim 18, wherein the received drug identification is associated with a drug to be taken by the patient, and wherein alerting the patient or the doctor occurs if the drug to be taken is: incorrect, out of date, out of compliance, and/or recalled.

20. The non-transitory computer readable medium of claim 1, wherein the optical interference filter associated with the pharmaceutical dosage form is incorporated within, or on, a container holding the pharmaceutical dosage form.

21. The non-transitory computer readable medium of claim 1, wherein the container holding the pharmaceutical dosage form comprises a blister pack.

22. A computer-based patient compliance system, the system comprising:
one or more computer readable storage devices configured to store a plurality of computer executable instructions; and
one or more hardware computer processors in communication with the one or more computer readable storage devices and configured to execute the plurality of computer executable instructions in order to cause the computer system to:
receive patient-identifying information associated with a patient;
receive a drug identification associated with a pharmaceutical dosage form associated with a microtag, wherein the drug identification is obtained by:
scanning the microtag associated with the pharmaceutical dosage form via an emitter configured to emit an electromagnetic wave, wherein the microtag has a varying porosity based on one or more etching currents used to manufacture the microtag, each etching current having variable parameters;
receiving an energy spectrum associated with the microtag via a receiver configured to receive the energy spectrum, wherein the energy spectrum is based on the electromagnetic wave interacting with the varying porosity of the microtag;
determining one or more spectral energy features from the energy spectrum, wherein each spectral energy feature has characteristics partly determined by the variable parameters of one of the etching currents used to manufacture the microtag;
determining a unique scanned tag code based on the characteristics of the one or more spectral energy features from the energy spectrum, wherein the unique scanned tag code is associated with the microtag associated with the pharmaceutical dosage form;
comparing the unique scanned tag code to a database containing the drug identification in order to determine a match; and
upon determining the match, determining the drug identification associated with the unique scanned tag code and the microtag;
access a patient-record database containing an electronic prescription associated with the patient;
determine the electronic prescription associated with the patient based on the received patient-identifying information associated with the patient;
compare the received drug identification to the electronic prescription associated with the patient to determine patient compliance; and
generate or update a patient compliance report based on the determined patient compliance.

23. A computer-based patient compliance system, the system comprising:
one or more computer readable storage devices configured to store a plurality of computer executable instructions; and
one or more hardware computer processors in communication with the one or more computer readable storage devices and configured to execute the plurality of computer executable instructions in order to cause the computer system to:
receive patient-identifying information associated with a patient;
receive, from a scanning device, one or more drug identifications, wherein each drug identification is obtained from a pharmaceutical dosage form that is associated with a microtag, and wherein each drug identification is obtained by:
scanning the microtag associated with the pharmaceutical dosage form via an emitter configured to emit an electromagnetic wave, wherein the microtag has a varying porosity based on one or more etching currents used to manufacture the microtag, each etching current having variable parameters;
receiving an energy spectrum associated with the microtag via a receiver configured to receive the energy spectrum, wherein the energy spectrum is based on the electromagnetic wave interacting with the varying porosity of the microtag;
determining one or more spectral energy features from the energy spectrum, wherein each spectral energy feature has characteristics partly determined by the variable parameters of one of the etching currents used to manufacture the microtag;
determining a unique scanned tag code based on the characteristics of the one or more spectral energy features from the energy spectrum, wherein the unique scanned tag code is associated with the microtag associated with the pharmaceutical dosage form;
comparing the unique scanned tag code to a database containing drug information in order to determine a match; and
upon determining the match, determining the drug identification associated with the unique scanned tag code and the microtag;
access a patient-record database containing an electronic medical record associated with the patient;
determine the electronic medical record associated with the patient based on the received patient-identifying information associated with the patient;
determine, from the electronic medical record, a list of drugs prescribed to the patient;
compare the two or more received drug identifications to the list of drugs prescribed to the patient;
determine any adverse drug interactions between the drugs in the list of drugs prescribed to the patient and the two or more received drug identifications; and
generate a drug interaction report identifying any determined adverse drug interactions between the drugs in the list of drugs prescribed to the patient and the two or more received drug identifications.

24. The computer-based patient compliance system of claim 23, wherein the scanning device comprises:
the emitter configured to emit the electromagnetic wave;
the receiver configured to receive the energy spectrum based on the interaction of the electromagnetic wave and the microtag;
a cartridge receiver, wherein the cartridge receiver is configured to receive a cartridge containing the one or more pharmaceutical dosage forms;
a pharmaceutical dosage form selection mechanism, wherein the pharmaceutical dosage form selection mechanism is configured to select individual pharmaceutical dosage forms in the cartridge for drug identification;
one or more computer readable storage devices configured to store a plurality of computer executable instructions; and
one or more hardware computer processors in communication with the one or more computer readable storage devices and configured to execute the plurality of computer executable instructions in order to cause the scanning device to:
determine that the cartridge receiver has received a cartridge containing the one or more pharmaceutical dosage forms;
determine a total number of pharmaceutical dosage forms in the cartridge;
emit, via the emitter, an electromagnetic wave at a single pharmaceutical dosage form in the cartridge;
receive, via the receiver, the energy spectrum based on the interaction of the electromagnetic wave and the microtag associated with the single pharmaceutical dosage form;
determine the one or more spectral energy features from the received energy spectrum;
determine the unique scanned tag code based on the characteristics of the one or more spectral energy features;
access the database containing the drug identification;
compare the unique scanned tag code to the database containing the drug identification to determine a match;
determine the drug identification associated with the unique scanned tag code and the microtag associated with the single pharmaceutical dosage form;
operate the pharmaceutical dosage form selection mechanism to select a different pharmaceutical dosage form in the cartridge unless the drug identification for the total number of pharmaceutical dosage forms in the cartridge has been determined; and
send one or more drug identifications corresponding to the total number of pharmaceutical dosage forms in the cartridge to the computer-based patient compliance system.
